(19) United States
(12) Patent Application Publication
(10) Pub. No.: US 2016/0286502 A1
(43) Pub. Date: Sep. 29, 2016

(54) WIRELESS COMMUNICATION APPARATUS AND TRANSMISSION POWER CONTROL METHOD

(71) Applicant: Panasonic Intellectual Property Management Co., Ltd., Osaka (JP)

(72) Inventor: Toshiyuki Sugitani, Saga (JP)

(21) Appl. No.: 15/034,736

(22) PCT Filed: Aug. 26, 2014
(86) PCT No.: PCT/JP2014/004374

§ 371 Date: May 5, 2016

(30) Foreign Application Priority Data
Nov. 8, 2013 (JP) 2013-232390

(51) Int. Cl. H04W 52/24; H04W 72/04

(52) U.S. Cl. CPC H04W 52/245; H04W 72/0406; H04W 52/242

(57) ABSTRACT

A base unit transmits information indicating a transmission power value of the base unit to a handset using a channel for transmitting a control signal during standby state. The handset measures a received signal strength indicator level of the control signal transmitted from the base unit, determines a transmission power value of the handset from the measured value of the received signal strength indicator level and information of the transmission power value of the base unit, and transmits a signal including a notification message including the information indicating the transmission power value of handset to the base unit using only one predetermined slot at predetermined time intervals.

### TECHNICAL FIELD

The present invention relates to a wireless communication apparatus and a transmission power control method applicable to a digital cordless telephone.

### BACKGROUND ART

Cordless telephones having a cordless handset and enabling a conversation with a person at a distance from a base unit connected to a telephone line are widely used. With this widespread use, situations where a plurality of radio communication systems exist in the same area have arisen. If the base unit always transmits a radio signal with the maximum power in such situations, although communication is made possible between the base unit and the handset at a distance from one another, there arises a problem in that the radio used for the communication causes significant interference to other radio communication systems.

Given this, cordless telephones variably controlling the transmission power value of the base unit have been developed. For example, PTL 1 discloses a technique that makes a control such that the transmission power value of a wireless communication apparatus is set to the maximum at the start of communication and the transmission power value is reduced by a predetermined amount each time transmission succeeds and increased by a predetermined amount when transmission fails, for example. This technique disclosed in PTL 1 enables setting of an optimum transmission power value.

PTL 2 discloses a technique that controls the transmission power value of the base unit (connection apparatus) in accordance with whether or not a handset is linked to a charging cradle. That is, PTL 2 discloses the technique whereby communication is done with a low transmission power value when the handset is linked to the charging cradle and communication is done with a high transmission power value when the handset is removed from the charging cradle. By doing this, the technique disclosed in PTL 2 enables maintenance of communication between a handset and a connection apparatus even if an interfering signal is received in the process of the handset moving away from the connection apparatus.

### CITATION LIST

### Patent Literature

PTL 1: Japanese Patent Application Laid-Open No. 2001-332987

PTL 2: Japanese Patent Application Laid-Open No. 2002-345026

### SUMMARY OF INVENTION

### Technical Problem

Conventional digital cordless telephones, radio intercom systems, or the like perform radio communication with an upper limit transmission power value allowed in the Radio Law regardless of a positional relationship between a base unit and a handset. Accordingly, if a plurality of devices are deployed in a narrow area and perform communication at the same time, mutual interference with other systems may arise, which may deteriorate communication quality.

FIG. 1 shows how interference with respect to another nearby cordless telephone system occurs. As shown in FIG. 1, a case is assumed where there are a plurality of handsets (handsets A and B) registered to a base unit. In this case, if the transmission power value on the control channel is set to the maximum to enable reception of a control signal at the distant handset B, there is a risk of great interference with respect to another nearby cordless telephone system. The control signal is a signal transmitted by the base unit, and the control channel is a channel for transmitting the control signal.

According to the technique of PTL 1, if each device knows a transmission power value of its communication counterpart, each device can measure a received signal strength indicator level of a signal transmitted from the communication counterpart device. Each device can then calculate a propagation loss between the device and the counterpart device, and can determine the transmission power value appropriately based on the propagation loss. Even when one of the devices is a portable mobile terminal (such as a handset of a cordless telephone, a smartphone or a tablet terminal), the device can appropriately determine the transmission power value if the other device can recognize the transmission power value of the counterpart device in real time.

However, with the technique of PTL 1, when the transmission power value of the counterpart device is changed according to the situation, the device cannot determine the transmission power value of the device appropriately if the device cannot recognize the transmission power value of the counterpart device in real time. Further, with the technique of PTL 1, if one of the devices suspends transmission for a relatively long period of time, the device which resumes communication cannot accurately recognize the transmission power value of the counterpart device at that time. Accordingly, the device which resumes communication cannot determine the transmission power value appropriately.

With the technique of PTL 2, it is necessary to transmit a notification message to the communication counterpart as soon as the handset is removed from a charging cradle. If one or both of the devices perform intermittent operation in which transmission of signals is suspended for a predetermined period of time during a standby state in order to reduce unnecessary radiation or power consumption, the base unit (connection apparatus) cannot resume communication with the handset immediately after the handset is removed from the charging cradle. The base unit therefore cannot increase the transmission power value.

Further, when the handset changes the transmission power value, if the handset establishes a radio link with the base unit only for notifying the base unit of the transmission power value, power consumption of the handset increases by operation for establishing the radio link. Accordingly, radio resources (slots and channels) are wastefully occupied.

It is therefore an object of the present invention to provide a wireless communication apparatus and a transmission power control method which can minimize radio wave interference to another radio communication system by controlling a transmission power value at both a base unit and a handset, and further, avoid power consumption and use of radio resources for notifying the communication counterpart device of a transmission power value of the device.

### Solution to Problem

A wireless communication apparatus according to an aspect of the present invention includes: a base unit; and one or a plurality of handsets, in which: the base unit amplifies a control signal to a first transmission power value and transmits the control signal to each of the handsets using a control channel during a standby state, the control signal including information indicating the first transmission power value, and the control channel being used for transmitting the control signal; each of the handsets measures a received signal strength indicator level of the control signal and determines a second transmission power value based on the measured value of the received signal strength indicator level and the first transmission power value; each of the handsets amplifies a signal to a second transmission power value and transmits the signal to the base unit using only one slot at predetermined time intervals, the signal including information indicating the second transmission power value; and the base unit measures a received signal strength indicator level of the signal transmitted from each of the handsets and determines the first transmission power value based on the measured value of the received signal strength indicator level and the second transmission power value.

A transmission power control method according to an aspect of the present invention is a method in a wireless communication apparatus including a base unit and one or a plurality of handsets, the base unit performing radio communication in a time division multiple access (TDMA) scheme with each of the handsets in the wireless communication apparatus, the transmission power control method including: amplifying, by the base unit, a control signal to a first transmission power value, and transmitting from the base unit, the control signal to each of the handsets using a control channel, the control signal including information indicating the first transmission power value, and the control channel being used for transmitting the control signal; measuring, by each of the handsets, a received signal strength indicator level of the control signal; determining, by the each of the handsets, a second transmission power value based on the measured value of the received signal strength indicator level and the first transmission power value; amplifying, by each of the handsets, a signal to a second transmission power value, and transmitting the signal to the base unit using only one slot, the signal including information indicating the second transmission power value, the one slot having a predetermined positional relationship with the slot used for receiving the control signal; measuring, by the base unit, a received signal strength indicator level of the signal transmitted from each of the handsets; and determining, by the base unit, the first transmission power value based on the measured value of the received signal strength indicator level of the signal transmitted from each of the handsets and the second transmission power value.

### Advantageous Effects of Invention

According to the present invention, by controlling transmission power values at both a base unit and a handset, it is possible to minimize radio wave interference to another radio communication system. Further, by transmitting a notification message for notifying the base unit of a transmission power value from the handset using only one slot, it is possible to reduce power consumption of the handset required for the handset to perform notification of the transmission power value and wasteful use of radio resources.

### BRIEF DESCRIPTION OF DRAWINGS

FIG. 1 is a drawing showing how interference with respect to another nearby cordless telephone system occurs;

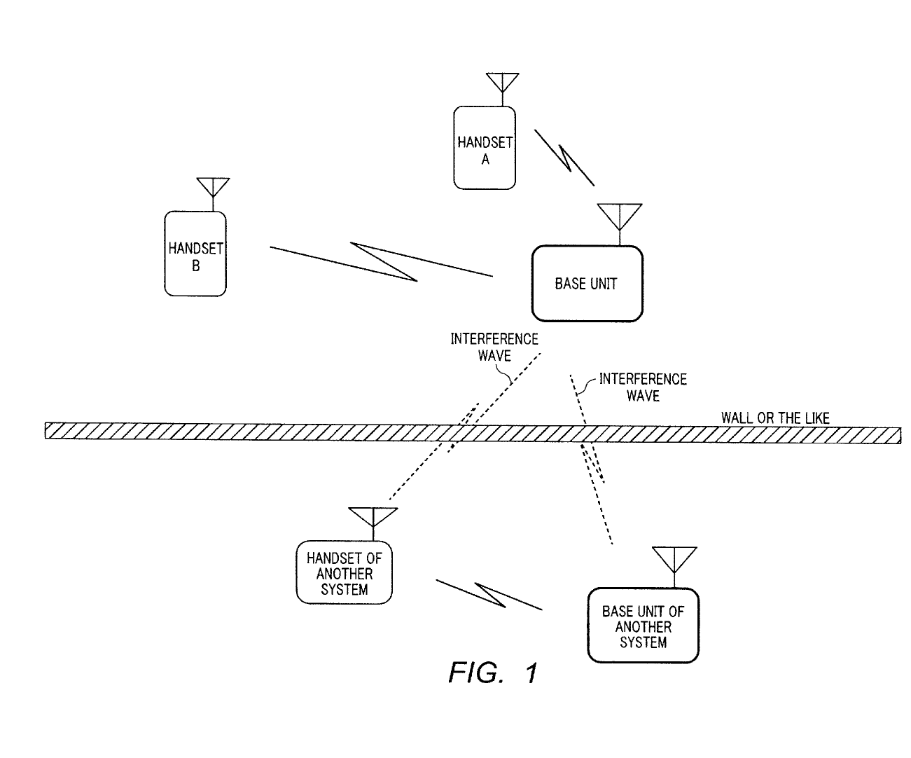

FIG. 2 is a block diagram showing the configuration of a base unit according to an embodiment of the present invention;

FIG. 3 is a block diagram showing the configuration of a handset and a charging cradle according to the embodiment concerned;

FIG. 4 is an outer view illustrating how a handset rests in a charging cradle according to the embodiment concerned;

FIG. 5 shows a frame and slot configuration of a radio signal according to a multiplexing scheme in a DECT system;

FIG. 6 shows a field configuration of a radio signal transmitted and received using one slot which is used in a radio communication system of the DECT system;

FIG. 7 is a drawing describing how communication is performed between the base unit and a handset in the standby state in the DECT system;

FIG. 8 is a drawing describing how communication is performed between the base unit and a handset in the call-in-progress state in the DECT system;

FIG. 9 is a drawing showing information stored in a memory section of a base unit according to an embodiment of the present invention;

FIG. 10 shows information stored in a memory section of a handset according to the embodiment concerned;

FIGS. 11A and 11B show how the base unit adjusts an area of a channel for transmitting a control signal according to the embodiment concerned;

FIG. 12 explains a relationship among transmission power values, a received signal strength indicator level, a propagation loss and a distance of the base unit and the handset according to the embodiment concerned;

FIG. 13 explains transmission of a notification message for transmission power control when the handset moves across a low power communication area and a high power communication area of the base unit in the embodiment concerned;

FIG. 14 explains a relationship between a propagation loss and a distance when the handset switches from low power to high power and from high power to low power, and a timing of the notification message to be transmitted from the handset to the base unit in the embodiment concerned;

FIG. 15 explains notification of information indicating a transmission power value during a standby state and the notification message for transmission power control in the embodiment concerned;

FIG. 16 is a timing chart indicating that a plurality of handsets transmit notification messages for transmission power control to the base unit at predetermined time intervals in the embodiment concerned;

FIG. 17 explains transmission of a notification message for transmission power control for confirming whether handsets are alive during a standby state and an alive confirmation request in the embodiment concerned;

FIG. 18 explains transmission power control in a call channel during a call in the embodiment concerned;

FIG. 19 is a flowchart showing an example of operation of the base unit and the handset in the embodiment concerned;

FIG. 20 is a flowchart showing a transmission power control procedure of the handset in the embodiment concerned;

FIG. 21 shows notification of a received signal strength indicator level when the base unit receives sensor information from the handset in Embodiment 2 of the present invention;

FIG. 22 shows an association with an intercom system base unit or the like in Embodiment 3 of the present invention;

FIG. 23 is a sequence diagram showing a mechanism for avoiding interference to adjacent another cordless telephone system in Embodiment 4 of the present invention;

FIGS. 24A and 24B show examples how information is displayed on the handset according to the embodiments of the present invention; and

FIG. 25 is a timing chart indicating that a plurality of handsets transmit notification messages for transmission power control to the base unit at predetermined time intervals in Embodiment 5 of the present invention.

### DESCRIPTION OF EMBODIMENTS

Embodiments of the present invention will be described in detail below with references made to the drawings. In the following, a digital cordless telephone conforming to the DECT (Digital Enhanced Cordless Telecommunication) standard is described as an example. DECT is a system that has been established as a standard by ETSI (European Telecommunications Standards Institute), which is a telecommunications standardization organization in Europe.

### Embodiment 1

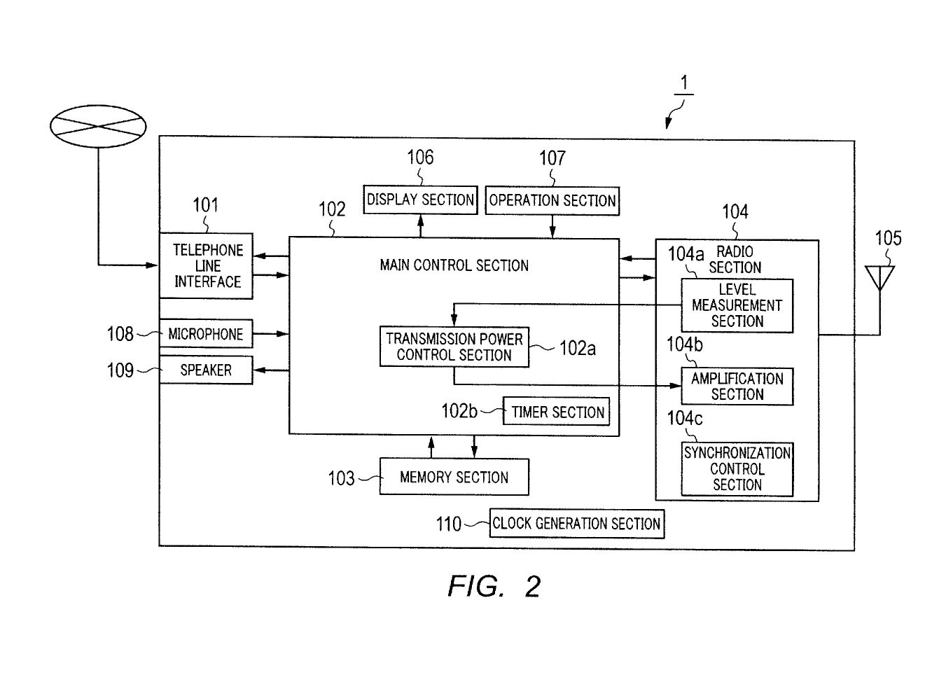

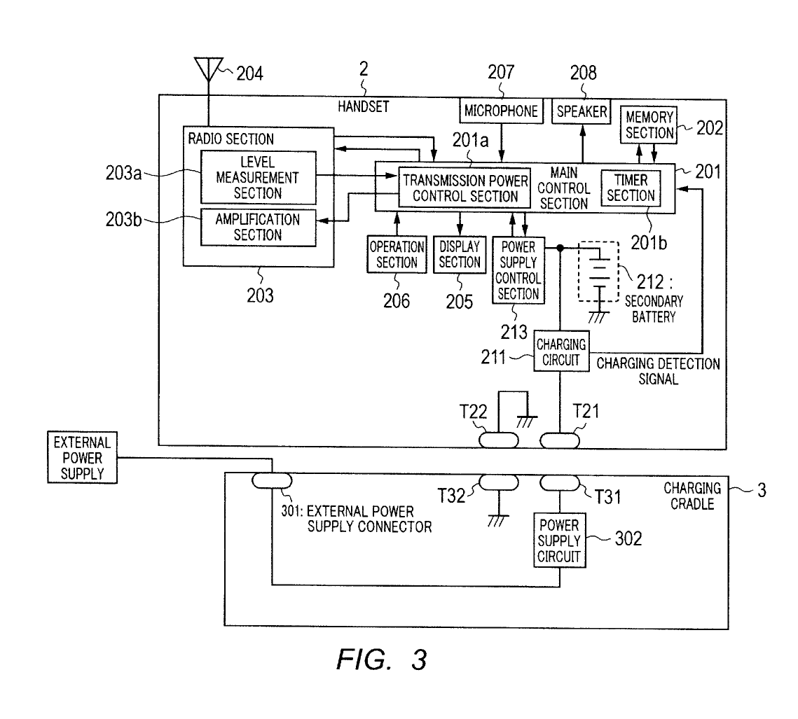

A digital cordless telephone includes one base unit (refer to FIG. 2), one or a plurality handsets 2 (refer to FIG. 3), and the same number of charging cradles 3 (refer to FIG. 3) as that of handsets 2. Base unit 1 (wireless communication apparatus) performs radio communication with each handsets 2 by the TDMA (time division multiple access) system.

FIG. 2 is a block diagram showing the configuration of base unit 1 according to an embodiment of the present invention. As shown in FIG. 2, base unit 1 mainly includes telephone line interface 101, main control section 102, memory section 103, radio section 104, antenna 105, display section 106, operation section 107, microphone 108, speaker 109, and clock generation section 110.

Telephone line interface 101 is an interface for connecting a telephone line with main control section 102. Telephone line interface 101 performs incoming call-receiving processing and call-originating processing to connect to an outside telephone via the telephone line and performs release and closing of the telephone line.

Main control section 102 includes CPU and, based on a control program stored in memory section 103, processes signals output from various sections and controls various sections. In particular, main control section 102 encodes digital voice data by the ADPCM (adaptive differential pulse code modulation) system, adds control data thereto, inserts it into a predetermined slot within a frame, performs modulation processing such as frequency modulation, and generates a baseband transmitted signal. Main control section 102 demodulates the received baseband signal, extracts control data and encoded voice data from a predetermined slot within the frame, decodes the encoded voice data by the ADPCM system, and generates digital voice data.

Memory section 103 stores, for example, a control program used by main control section 102 and various data. Further, memory section 103 includes a working memory for main control section 102 and a table for recording a variety of information. A registration information recording section (not shown) of memory section 103 stores an ID (Identification) of base unit 1 itself, an ID of each handset 2 which is a communication counterpart, IDs of other handsets, or the like. Of the information stored in memory section 103, the parts that are related to the present invention will be described later.

Radio section 104 amplifies and performs radio processing such as up-conversion with respect to the baseband digital signal output from main control section 102, and transmits a radio signal from antenna 105. Radio section 104 also amplifies and performs radio processing such as down-conversion of a radio signal received at antenna 105 and outputs a baseband digital signal to main control section 102.

Display section (LCD: liquid crystal display) 106 displays various information output from main control section 102. Operation section 107 has various buttons, dials, and keys and converts operations based on a user's intention to electrical signals, and outputs the signals to main control section 102.

Microphone 108 collects sounds from a user's voice, converts these to a voice signal, and outputs the signal to main control section 102. Speaker 109 which includes a compact speaker, outputs a notification sound when a calling signal is received from telephone line interface 101, and converts the voice signal output from main control section 102 into a voice and outputs the voice.

Clock generation section 110 generates a clock signal used by each section of base unit 1 to perform operation.

Here, as a characteristic configuration of the present invention, main control section 102 has transmission power control section 102a and timer section 102b. Further, radio section 104 has level measurement section 104a, amplification section 104b and synchronization control section 104c.

Transmission power control section 102a calculates a transmission power value based on a received signal strength indicator level (RSSI) level of a received signal from each handset 2 measured at level measurement section 104a. Transmission power control section 102a outputs a control signal indicating a calculation result to amplification section 104b. The specific transmission power control method in transmission power control section 102a will be described later.

Timer section 102b times a predetermined time such as a sleep time.

Level measurement section 104a measures a received signal strength indicator level of the received signal from handset 2 and outputs an RSSI signal which indicates the measured value of the received signal strength indicator level to transmission power control section 102a.

Amplification section 104b, amplifies the power of the radio signal transmitted from antenna 105, based on control by transmission power control section 102a.

When radio section 104 performs radio communication using a DECT protocol, synchronization control section 104c determines a communication timing of a communication signal used by radio section 104 based on a reference clock of clock generation section 110.

FIG. 3 is a block diagram showing the configuration of handset 2 and charging cradle 3 according to an embodiment of the present invention. As shown in FIG. 3, handset 2 mainly includes main control section 201, memory section 202, radio section 203, antenna 204, display section 205, operation section 206, microphone 207, speaker 208, charging circuit 211, secondary battery 212, and power supply control section 213. Handset 2 also has terminals T21 and T22.

Main control section 201, based on a control program stored in memory section 202, processes signals output from various sections and controls various sections. Further, upon reception of a charging detection signal from charging circuit 211, main control section 201 transmits a placement notification message to base unit 1 via radio section 203 and antenna 204. Here, the placement notification message is a notification message for making notification that handset 2 has been placed onto charging cradle 3.

When the charging detection signal that has been output from charging circuit 211 stops, main control section 201 transmits to base unit 1, via radio section 203 and antenna 204, a removal notification message. Here, the removal notification message is a notification message for making notification that handset 2 has been removed from charging cradle 3.

Memory section 202 stores predetermined information such as a control program.

Radio section 203 performs radio processing such as amplification and up-conversion of the baseband digital signal output from main control section 201 and transmits a radio signal from antenna 204. Radio section 203 also performs radio processing such as amplification and down-conversion of the radio signal received at the antenna 204 and outputs a baseband digital signal to main control section 201.

Display section 205 displays various information output from main control section 201. Operation section 206 has various buttons, dials, and keys, and converts operations based on a user's intention to electrical signals, and outputs them to main control section 201.

Microphone 207 collects sounds from a user's voice, converts these to a voice signal, and outputs the signal to main control section 201. Speaker 208 converts the voice signal output from main control section 201 to a voice and outputs the voice.

Terminals T21 and T22 are for inputting a charging current by making contact with terminals T31 and T32 when handset 2 is placed into charging cradle 3.

Charging circuit 211 receives, as input, a charging current supplied from charging cradle 3 and supplies the current to secondary battery 212 and power supply control section 213. When handset 2 is placed into charging cradle 3 and a charging current from charging cradle 3 is detected, charging circuit 211 outputs a charging detection signal to main control section 201. When handset 2 is removed from charging cradle 3 in which handset 2 had been placed and the charging current is no longer detected from charging cradle 3, charging circuit 211 stops outputting the charging detection signal.

Secondary battery 212 accumulates the charging current from charging circuit 211 and discharges into power supply control section 213. Power supply control section 213 is a voltage-regulated source supplying a stabilized DC voltage to main control section 201. Power supply control section 213 converts a DC voltage from charging circuit 211 or secondary battery 212 (for example, 2.5 V) to a lower voltage (for example, 1.8 V).

Charging cradle 3, as shown in FIG. 3, mainly includes external power supply connector 301 and power supply circuit 302, and also includes terminals T31 and T32. Terminals T31 and T32 are for supplying a charging current to handset 2.

External power supply connector 301 connects to an external power supply and receives a DC current as input. Power supply circuit 302 is a DC/DC converter that converts DC voltage from external power supply connector 301 (for example, 6.5 V) to an appropriate voltage (for example, 2.5 V) and supplies the voltage to charging circuit 211 of handset 2.

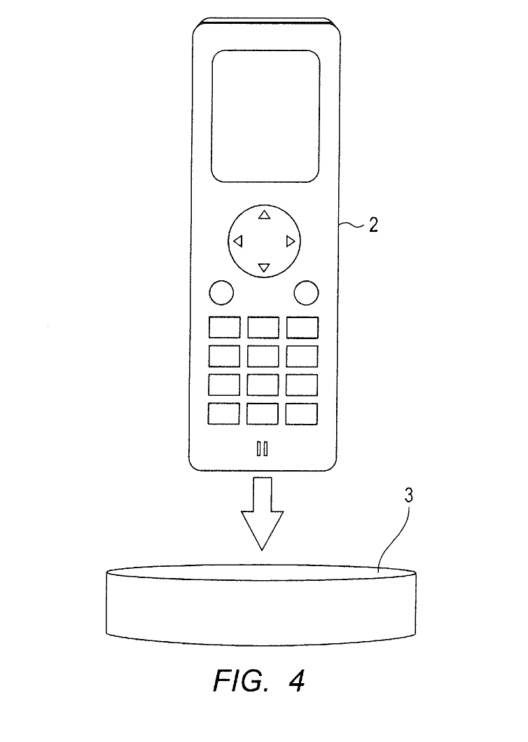

Handset 2 is configured to enable easy placement into and removal from charging cradle 3 as shown in FIG. 4. When handset 2 is placed into charging cradle 3, it is electrically connected to charging cradle 3, and a charging current from charging cradle 3 is accumulated in secondary battery 212. There are base units 1 configured to enable charging of handset 2. In case of such base unit 1, when being placed into the charging part of base unit 1, handset 2 is electrically connected to the charging part of base unit 1, and a charging current from base unit 1 is accumulated in secondary battery 212.

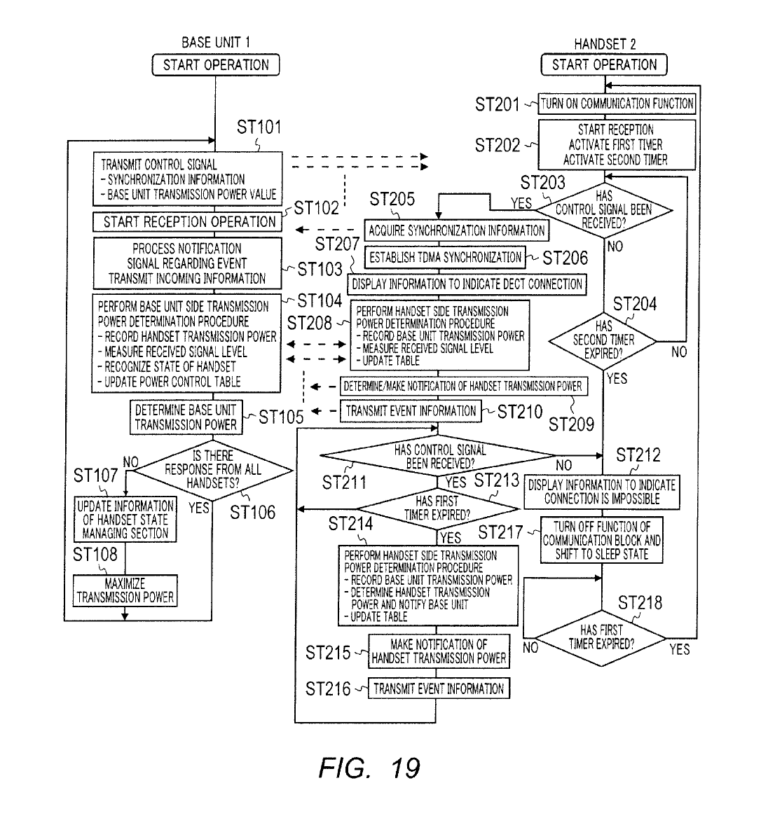

Intermittent operation of handset 2 will be described below. Power supply control section 213 of handset 2 has a switching function for switching power of a power supply between high and low other than a constant voltage stabilization function. Timer section 201b (first timer in FIG. 19) of main control section 201 times a sleep time. Main control section 201 switches a switch of power supply control section 213 to high every time the sleep time reaches an expiration value (about 5 minutes), and supplies power for enabling operation to radio section 203.

Meanwhile, when the switch of power supply control section 213 is switched to low, main control section 201 shuts off supplying power to radio section 203. Further, when the switch is in low, main control section 201 enters the sleep state, and power supply control section 213 supplies minimal necessary power to main control section 201. The minimal necessary power for main control section 201 is power which allows timer section 201b and a low-speed clock circuit to continue operation.

When the switch of power supply control section 213 is switched to high, radio section 203 starts operation. When communication becomes possible with base unit 1 as a result of radio section 203 starting operation, various operation required for communication is performed by control of main control section 201.

When operation necessary for communication is finished, main control section 201 issues an instruction to return the switch to low to power supply control section 213. Main control section 201 enters the sleep state as a result of the state of power supply control section 213 being switched to a low power state. In this way, handset 2 performs intermittent communication.

It should be noted that handset 2 may completely stop operation of main parts during intermittent communication. For example, it is desirable to minimize power consumption during a standby state for a handset such as a handset with a camera function which takes an image only when needed and a handset with a sensor which detects opening and closing of a window. Therefore, handset 2 is preferably configured to have these functions.

In this case, a switch function of power supply control section 213 of handset 2 switches power of the power supply between on and off. Power is supplied to radio section 203 and main control section 201 only when power supply control section 213 is switched on. That is, power is not supplied to radio section 203 and main control section 201 when power supply control section 213 is switched off.

However, even when power supply control section 213 is switched off, power is supplied to timer section 201b from a battery. Timer section 201b constantly operates a low-speed clock circuit to perform count operation.

Every time a count value of timer section 201b reaches an expiration value (about 1 hour), power supply control section 213 is switched on, and power is supplied to main control section 201 and radio section 203. Various operation required for communication is performed by control of main control section 201.

When operation necessary for communication is finished, main control section 201 issues an instruction to switch off power supply control section 213. Power supply control section 213 is switched off and stops supplying power to main control section 201 and radio section 203. By this means, main control section 201 enters the sleep state. Because handset 2 has a function of completely turning off the power supplies of the main sections during a sleep state (ULE: Ultra Low Energy), it is possible to drastically reduce power consumption.

Further, as a characteristic configuration of the present invention, main control section 201 has transmission power control section 201a. Further, radio section 203 has level measurement section 203a and amplification section 203b. Level measurement section 203a measures a received signal strength indicator level (RSSI) level of a received signal from base unit 1.

Transmission power control section 201a determines a propagation loss (corresponding to a distance to base unit 1) based on a transmission power value of base unit 1 notified in information within a control signal from base unit 1 and a received signal strength indicator (RSSI) level of the control signal from base unit 1. Transmission power control section 201a calculates a transmission power value of handset 2 from a determination result and records the transmission power value in memory section 202. Further, transmission power control section 201a controls amplification section 203b so as to transmit a signal at the calculated transmission power value. Amplification section 203b amplifies a radio signal based on control by transmission power control section 201a.

Further, main control section 201 transmits various notification messages to base unit 1 at regular timings by a built-in counter. Particularly, main control section 201 reads out the latest transmission power value of handset 2 which is stored in memory section 202 at notification timings of once every nearly 5 minutes and transmits a message indicating the transmission power value to base unit 1.

Further, when the propagation loss with base unit 1 calculated as described above becomes lower than a predetermined reference value, main control section 201 transmits a notification message for setting the transmission power value to full power to base unit 1 without performing transmission power control. Further, also in a case where the control signal of base unit 1 cannot be correctly received, main control section 201 transmits the notification message to base unit 1. Note that a specific transmission power control method in transmission power control section 201a of handset 2 will be described later.

Communication control in a case where communication is performed using a DECT system will be described next. First, multiplex communication in the DECT system will be described.

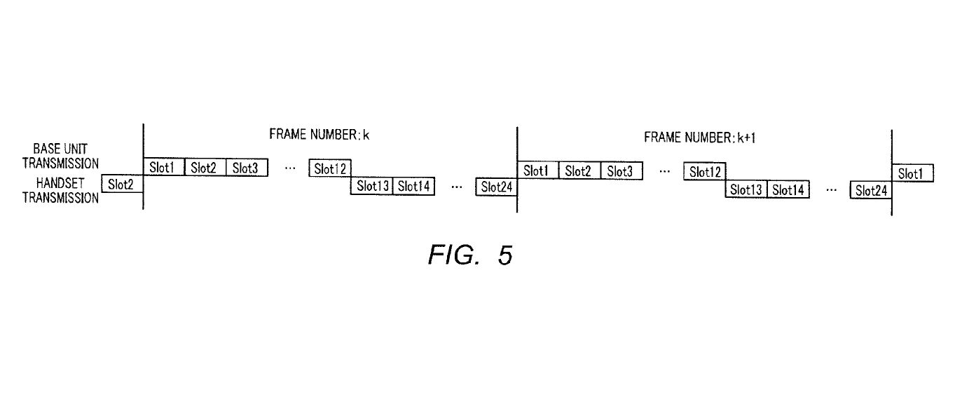

FIG. 5 shows a configuration of frames and slots of a radio signal according to a multiplexing scheme in the DECT system. As shown in FIG. 5, in the DECT system, radio multiplex communication is performed using a TDMA/TDD (Time Division Multiple Access/Time Division Duplex) scheme in which one frame with a cycle of 10 ms is divided into 24 slots (12 slots for uplink and 12 slots for downlink). Further, in the DECT system, 5 frequencies can be used for communication.

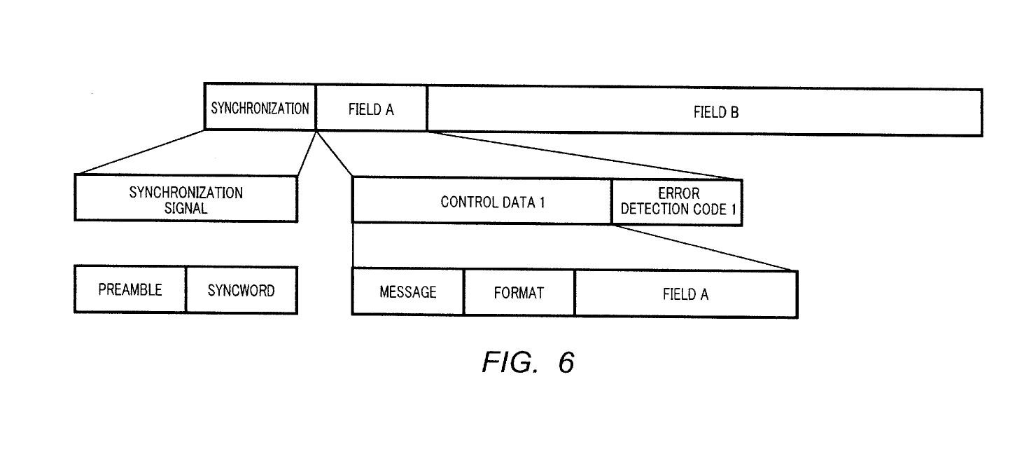

A field configuration of the radio signal in the DECT system will be described next. FIG. 6 shows a field configuration of a radio signal to be transmitted and received in one slot which is used in the radio communication system of the DECT system. As shown in FIG. 6, the radio signal to be transmitted and received using one slot that includes three fields: a synchronization field; field A; and field B.

The synchronization field is a field for a synchronization signal, which includes a preamble for achieving synchronization of bit timings and a syncword for detecting a starting position of subsequent field A. Field A is a field for a message type indicating a type of a message of field A and format identification information indicating a data format of field B. Further, field A is a field for control data 1 including the message of field A and error detection code 1 for detecting reception error of data received in field A.

Field B is a field used in a format according to the application. Field B is a field for control data for communication control, voice data for voice communication, image data for image communication and a message for message communication.

A message for radio communication control in the DECT system will be described next. The message for radio communication control in the DECT system is classified into an NT message, an MT message, a PT message, a QT message and a CT message.

The NT message is a message used by the base unit to notify the handset of the identification number of the base unit itself (that is, base unit ID). The base unit transmits a control signal, which will be described later, including the NT message. The handset selects the base unit for performing communication with the handset using the received NT message. Further, the NT message is used for designating the base unit when the handset performs transmission.

The MT message is a message used for establishing, maintaining and disconnecting a radio link between the base unit and the handset. Further, in the present invention, the MT message is used by the handset to notify the base unit of a transmission power value.

The PT message is a message used for paging in order to call a subordinate station from a control station. Further, in the present invention, the PT message is used by the control station to notify the subordinate station of a transmission power value.

The QT message is a message used for notification of information required to establish synchronization of frames and slots such as frame numbers and slot numbers, for example.

The CT message is a message used for call control or authentication. Further, in the present invention, the CT message is used by the control station to request transmission of a notification message of a transmission power value to the subordinate station.

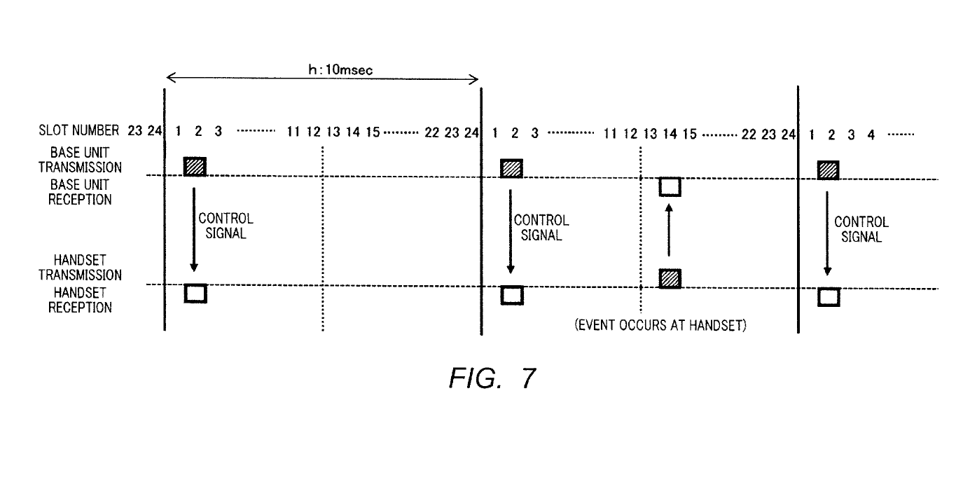

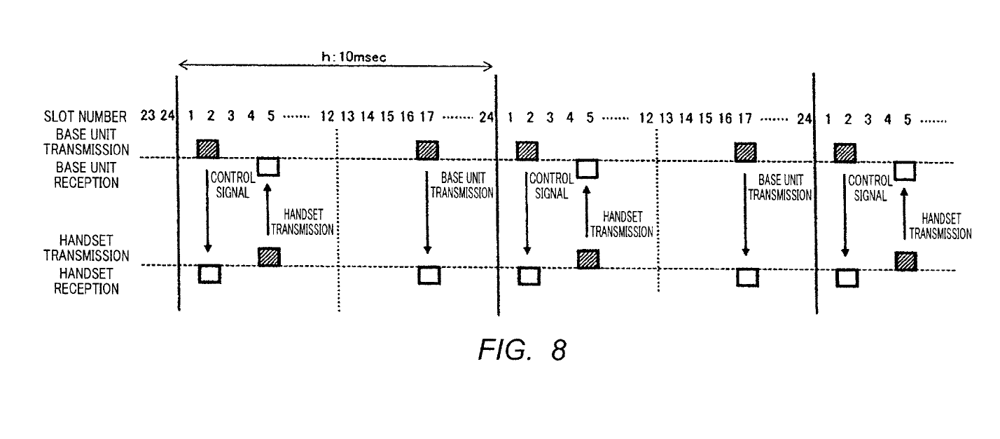

Communication between base unit 1 and handset 2 during a standby state in the DECT system will be described next using FIG. 7 and FIG. 8.

As shown in FIG. 7, in the DECT system, 24 slots (12 slots for uplink and 12 slots for downlink) are included in one frame with a cycle of 10 ms. Base unit 1 always transmits a control signal using a predetermined slot (the second slot in FIG. 7) for each frame. That is, base unit 1 determines a predetermined slot determined in advance of each frame as a channel (control channel) for transmitting a control signal, and transmits the control signal (Beacon) in a frame period of 10 ms using this control channel. Further, signals are transmitted and received in a frame period of 10 ms also in other call channels.

The control signal which has a function as a synchronization signal includes synchronization data (for example, syncword). Syncword, which is a known digit string determined in advance for timing syncrhonization, serves as synchronization information so that handset 2 can achieve synchronization. Handset 2 at a reception side starts cutout and capturing of a frame at a time point when this known digit string is found. In the DECT system, a unique syncword is assigned to each network, and a signal transmitted from each device includes this syncword.

Base unit 1 transmits an ID of base unit 1 using this control signal. Handset 2 acquires the ID of base unit 1 while receiving the control signal, compares the acquired ID with an ID of base unit 1 (registered base unit 1) for which handset 2 is waiting and selects base unit 1 to be synchronized.

As shown in FIG. 7, during a standby state, handset 2 does not transmit a signal to base unit 1. Handset 2 transmits a signal to base unit 1 for each frame only when handset 2 enters the calling state by occurrence of an event, or the like, such as call origination. Further, handset 2 regularly transmits a notification message to base unit 1. At that time, handset 2 transmits a notification message regarding the event to base unit 1 using a predetermined slot determined in advance. In the example of FIG. 7, handset 2 transmits the notification message using the fourteenth slot. Further, as will be described later, at several-minute intervals, handset 2 selects any slot to transmit various notification messages to base unit 1.

Communication between base unit 1 and a handset during a calling state in the DECT system will be described next using FIG. 8. Also during the calling state, base unit 1 transmits a control signal (Beacon) to handset 2 in a similar manner to the standby state. As a call channel for calling, a slot different from the slot of the control signal is used. Base unit 1 and handset 2 transmit and receive a voice signal using uplink and downlink slots (the fifth slot and the seventeenth slot in FIG. 8) designated by base unit 1 in each frame.

Base unit 1 in the present embodiment measures a received signal strength indicator level of a notification message (such as a transmission power notification message and an event notification message) transmitted from each handset 2. Base unit 1 calculates a propagation loss between each handset 2 and base unit 1 from the measurement result and controls a transmission power value of the base unit based on the calculation result. Further, handset 2 measures a received signal strength indicator level of a control signal (a transmission power notification message) transmitted from base unit 1. Handset 2 calculates a propagation loss between each handset 2 and base unit 1 from the measurement result and controls a transmission power value of the handset based on the calculation result. Transmission power control of base unit 1 and handset 2 will be described below.

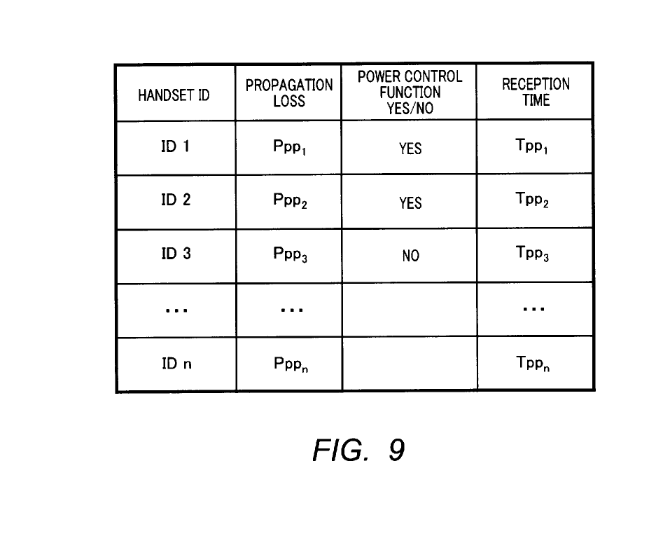

FIG. 9 shows information stored in memory section 103 of base unit 1 according to one embodiment of the present invention. As shown in FIG. 9, for each handset 2, an ID number (IDᵢ) of the handset, a propagation loss (Pppᵢ), information indicating whether or not each handset 2 has a function of power control, and a reception time of a notification message (Tppᵢ) are stored in memory section 103 of base unit 1 in association with one another. Here, the propagation loss (Pppᵢ) is a value calculated based on a received signal strength indicator level of a notification message, or the like (a transmission power notification message or an event notification message). Hereinafter, a table shown in FIG. 9 will be referred to as “base unit side transmission power control table.”

Level measurement section 104a measures a received signal strength indicator level of a notification message every time base unit 1 receives the notification message from each handset 2, and outputs the measured value of the received signal strength indicator level to main control section 102 (transmission power control section 102a).

Upon reception of a transmission power notification message from any of handset 2, main control section 102 calculates a propagation loss from transmission power of handset 2 (transmission power at the time when the transmission power notification message is transmitted) notified in the message and a received signal strength indicator level of the transmission power notification message notified from level measurement section 104a. Main control section 102 stores the ID of handset 2, the propagation loss and the reception time in memory section 103 in association with one another.

Further, main control section 102 sometimes receives a notification message (for example, an event notification message) other than the transmission power notification message from a handset (for example, a handset of ID3) for which information in memory section 103 indicates “non-existence” of a power control function. In this case, main control section 102 calculates a propagation loss based on a transmission power of handset 2 determined in advance (for example, 23 dbm if handset 2 is a handset of a cordless telephone of the DECT system) and the received signal strength indicator level of the notification message notified from level measurement section 104a. Main control section 102 stores the calculation result in memory section 103 in association with the ID of the handset, the propagation loss and the reception time.

Transmission power control section 102a calculates a transmission power value at a predetermined timing using a maximum value of the propagation loss (Pppᵢ) stored in memory section 103. Note that the timing at which transmission power control section 102a performs transmission power control includes a timing at which information content stored in memory section 103 illustrated in FIG. 9 is updated.

Specifically, transmission power control section 102a reads out each propagation loss (Pppᵢ) stored in memory section 103 when the notification message transmitted from each handset 2 is received, and selects a maximum value of the propagation loss (Pppᵢ). Each handset 2 which can perform communication with base unit 1 notifies base unit 1 of a transmission power value according to procedure which will be described later. Note that the transmission power value of each handset 2 which does not have a power control function is stored in advance in memory section 103 of base unit 1 when the product is manufactured.

In the present embodiment, the amplification of amplification section 104b at the time when a control signal is transmitted is controlled to suit handset 2 for which the received signal level of a signal from base unit 1 is the weakest. Specifically, base unit 1 reads out a propagation loss of handset 2 with the largest propagation loss from information stored in memory section 103 and determines the transmission power value so that a signal transmitted by base unit 1 reaches the communication counterpart (the handset) at a predetermined level or higher.

Transmission power control section 102a calculates a transmission power value for transmitting a control signal from base unit 1 according to a value obtained by adding a received power reference value to the propagation loss related to handset 2 for which the level of a signal from the base unit is the weakest. Note that the received power reference value is a received power value necessary for maintaining communication between base unit 1 and handset 2 or for avoiding communication interference, to which a margin is added.

Transmission power control section 102a controls amplification section 104b to transmit a signal with the calculated transmission power value. That is, amplification section 104b transmits a control signal with the transmission power value controlled by transmission power control section 102a when base unit 1 transmits the control signal using a channel (a control channel) for transmitting the control signal.

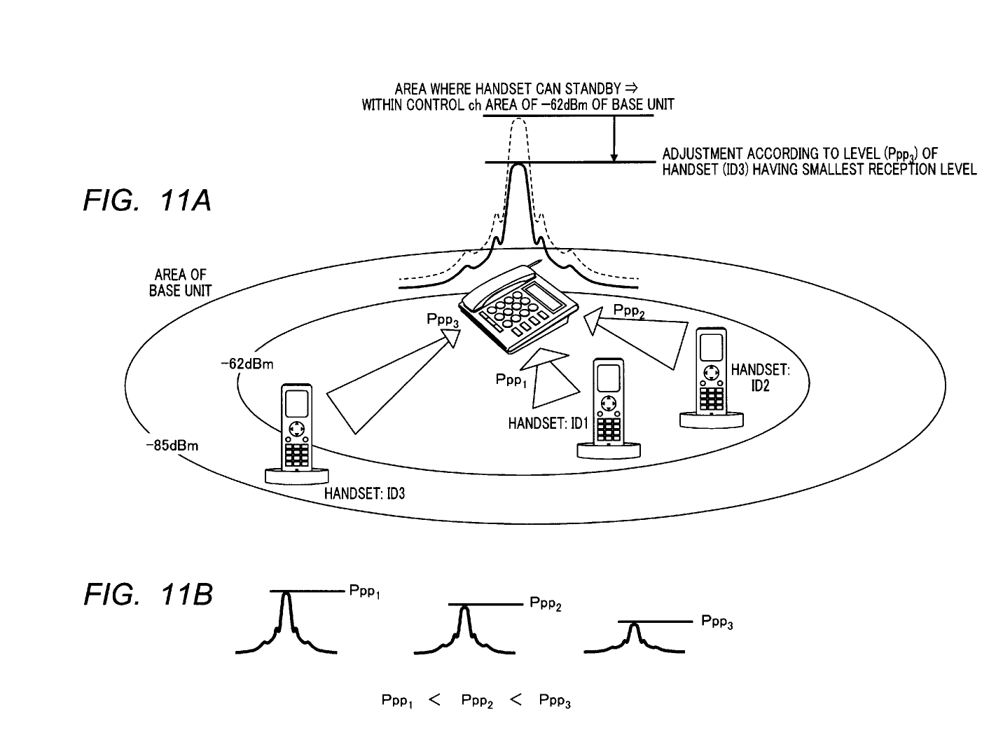

FIGS. 11A and 11B show how a signal receivable area when base unit 1 transmits a control signal using a channel (a control channel) for transmitting the control signal is adjusted. Here, a propagation loss calculated using a received signal strength indicator level of a notification message to be transmitted by a handset of ID1 is assumed to be Ppp₁, a propagation loss calculated using a received signal strength indicator level of a notification message to be transmitted by a handset of ID2 is assumed to be Ppp₂, and a propagation loss calculated using a received signal strength indicator level of a notification message to be transmitted by a handset of ID3 is assumed to be Ppp₃. In this case, if the relationship among the propagation losses of the handsets (ID1, ID2 and ID3) in base unit 1 is Ppp₁<Ppp₂<Ppp₃, base unit 1 calculates a transmission power value using the maximum value Ppp₃.

By this means, even if the handset exists away from base unit 1 and the propagation loss is large, it is possible to receive the control signal transmitted using the control channel at a received power value necessary for maintaining communication. It should be noted here that the control channel is a channel for transmitting a control signal from base unit 1 as described above. Further, because the transmission power value of base unit 1 is reduced, it is possible to avoid radio wave interference to another radio communication system. Further, transmission power control of the control signal transmitted from base unit 1 is very effective for increasing the number of systems accommodated per unit area.

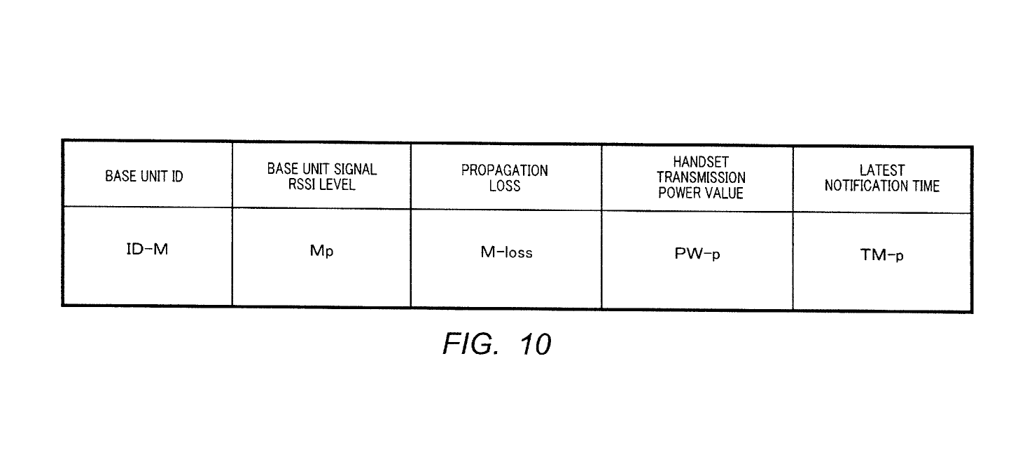

Next, information for transmission power control stored in memory section 202 of handset 2 according to one embodiment of the present invention will be described. FIG. 10 shows information stored in memory section 202 of handset 2 according to the embodiment of the present invention. As shown in FIG. 10, memory section 202 of handset 2 stores an ID number (ID-M) of registered base unit 1 and a received signal strength indicator level (an RSSI level of the base unit signal: Mp) measured when the control signal transmitted from base unit 1 is received. Further, memory section 202 of handset 2 stores a propagation loss (M-loss) between the handset and the base unit, a transmission power value (PW-p) of handset 2, and the latest notification time (TM-p) when base unit 1 is notified of the transmission power value of handset 2. Here, the propagation loss (M-loss) between the handset and the base unit is a value calculated from information indicating a measured value of the received signal strength indicator level of the control signal transmitted from base unit 1 and the transmission power value of base unit 1 notified using the control signal. Hereinafter, the table shown in FIG. 10 will be referred to as “handset side transmission power control table.”

Level measurement section 203a of handset 2 measures a received signal strength indicator level every time a control signal from base unit 1 is received during a standby state and outputs the measured value of the received signal strength indicator level to main control section 201. Main control section 201 stores the received signal strength indicator level (Mp) of the control signal in the handset side transmission power control table of memory section 202. Further, as will be described later, main control section 201 notifies base unit 1 of the transmission power value of handset 2 at a predetermined timing (regularly or when a predetermined event occurs).

The predetermined event is, for example, an event that handset 2 is removed from charging cradle 3. At this timing, main control section 201 notifies base unit 1 of the transmission power value of handset 2 on a removal notification message to be transmitted from handset 2 to base unit 1. Further, as another predetermined event, in the case of a handset with a sensor, when the sensor performs detection, main control section 201 notifies the base unit of the transmission power value of handset 2 on a detection message to be transmitted from handset 2 to base unit 1.

That is, main control section 201 is counted by timer section 201b (a first timer shown in FIG. 19). A propagation loss (M-loss) is regularly calculated from the information of the measured value of the received signal strength indicator level (Mp) and the transmission power value of base unit 1 at every 5-minute interval. Main control section 201 records the calculation result in the handset side transmission power control table of memory section 202. Further, transmission power control section 201a calculates the transmission power value (PW-p) of handset 2 based on a signal strength reference value (set in advance) necessary for normal reception at base unit 1 and the propagation loss. Transmission power control section 201a writes the calculation result in the handset side transmission power control table.

Transmission power control section 201a controls amplification section 203b to transmit a signal with the calculated transmission power value. That is, when handset 2 transmits a notification message, amplification section 203b transmits a control signal with the transmission power value controlled by transmission power control section 201a.

Main control section 201 notifies base unit 1 of the transmission power value of handset 2 at a predetermined timing (regularly or when a predetermined event occurs). Every time main control section 201 transmits the notification message including the transmission power value to base unit 1, main control section 201 records a notification time (TM-p) at that time in the handset side transmission power control table in association with the transmission power value of handset 2. As described above, transmission power control section 201a of main control section 201 calculates the transmission power value for transmitting the notification message from handset 2 and updates the handset side transmission power control table.

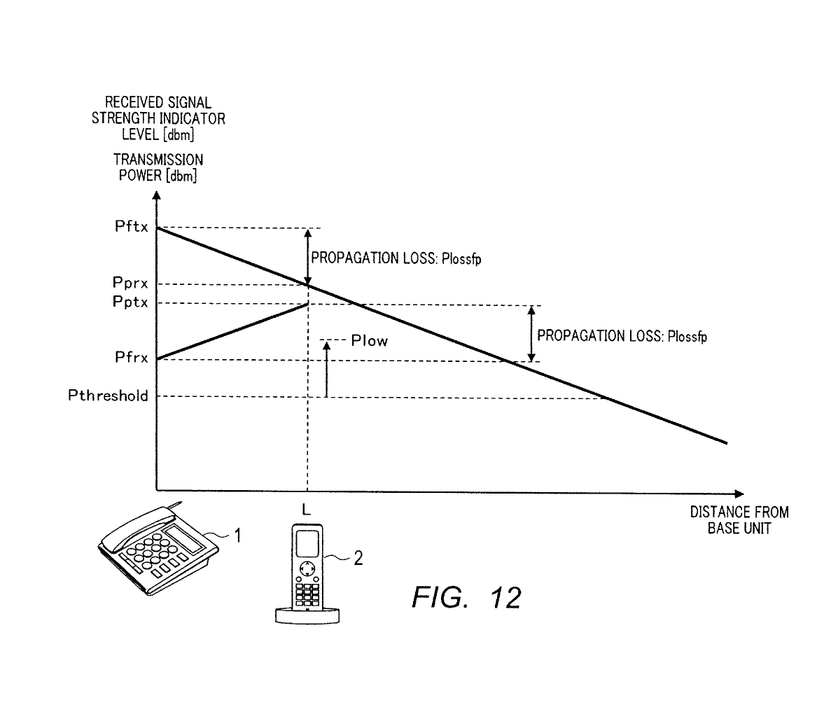

FIG. 12 is a diagram for describing a relationship among transmission power values, a received signal strength indicator level, a propagation loss and a distance of base unit 1 and handset 2. In FIG. 12, Pftx is a transmission power value of a base unit signal, Pprx is a received signal strength indicator level of the base unit signal at the handset, Pptx is a transmission power value of a handset signal, and Pfrx is a received signal strength indicator level of the handset signal at the base unit.

When transmission power of base unit 1 is assumed to be Pftx (dbm), and a received signal strength indicator level of handset 2 which is located away from base unit 1 by L (m) is assumed to be Pprx (dbm), a propagation loss Plossfp (db) at a communication path between base unit 1 and handset 2 can be obtained from the following expression (1):

Plossfp=Pftx−Pprx (Expression 1)

Meanwhile, an attenuation amount while a signal transmitted from handset 2 reaches base unit 1 is substantially equal to the above-described propagation loss Plossfp (db). Accordingly, when the handset which is located away from base unit 1 by L (m) outputs a signal of Pptx (dbm), the received signal strength indicator level Pfrx (dbm) of base unit 1 can be obtained from the following expression (2):

Pfrx=Pptx−Plosspf˜Pptx−Plossfp=Pptx−(Pftx−Pprx) (Expression 2)

A method for determining a transmission power value of a signal to be transmitted by handset 2 will be described below using FIG. 12. As shown in FIG. 12, when a lower limit value of a received signal strength indicator level with which normal reception is possible at a reception side (base unit 1) is assumed to be Pthreshold (dbm), a transmission power value Pptx of handset 2 is determined so that the received signal strength indicator level at base unit 1 is equal to or greater than Pthreshold. That is, first, the transmission power value of handset 2 is determined so that the received signal strength indicator level Pfrx of base unit 1 satisfies the following expression (3):

Pfrx>Pthreshold (Expression 3)

Further, expression (2) and expression (3) lead to the following expression (4). The transmission power value Pptx of handset 2 is required to satisfy the expression (4):

Pptx−(Pftx−Pprx)>Pthreshold Pptx−Pthreshold>Pftx−Pprx (Expression 4)

If a method is employed in which the transmission power value of handset 2 is selected from two levels of high power and low power, the transmission power value Plow (dbm) at the time of low power is set so as to satisfy the following expression (5):

Plow-Pthreshold>Pftx−Pprx (Expression 5)

As described above, regardless of types of handset 2, as long as handset 2 transmits the transmission power value of handset 2 to base unit 1 in the notification message, base unit 1 can perform appropriate transmission power control. Therefore, even if the types of handsets to be added increase, it is possible to perform transmission power control without changing the configuration of the base unit.

Further, base unit 1 stores whether or not to perform transmission power control for each handset and a maximum transmission power value of the handset which is known. Accordingly, when the handset does not have a transmission power control function and always operates at a fixed transmission power value, base unit 1 can perform appropriate transmission power control by receiving some signal such as event notification without receiving a notification message of the transmission power value from the handset. Note that in other embodiments which will be described later, base unit 1 is configured to support various handsets provided with a function of a sensor, a camera, or the like, other than a normal telephone handset as a handset.

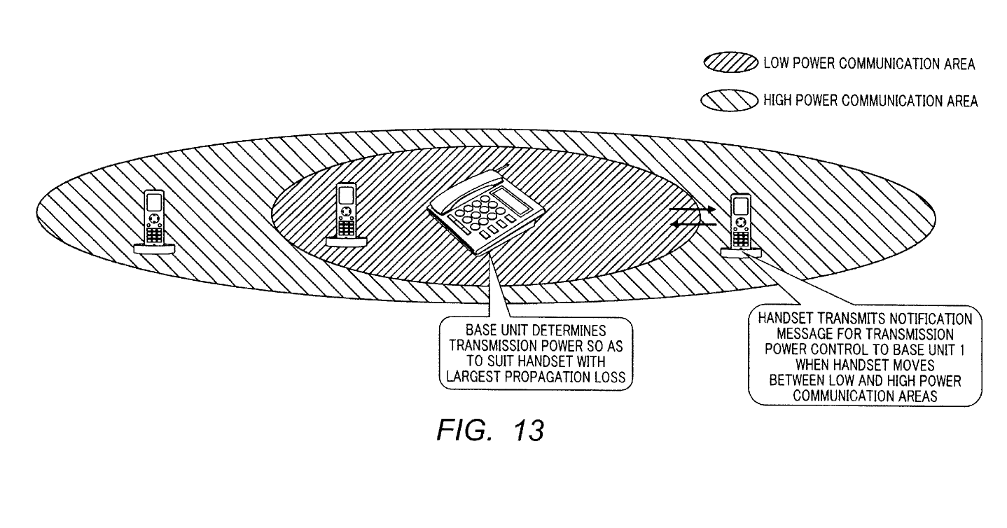

FIG. 13 shows transmission of a notification message for transmission power control when handset 2 moves across a low power communication area and a high power communication area of base unit 1 during a standby state.

In the present embodiment, base unit 1 informs the handset of information indicating a transmission power value using a channel (a control channel) for transmitting a control signal. Handset 2 informs base unit 1 of information indicating a transmission power value using a unique message (hereinafter, referred to as a notification message for transmission power control). By this means, transmission power control of the control signal is realized.

Handset 2 in a standby state recognizes a propagation loss between handset 2 and base unit 1 from the information indicating the transmission power value of the control signal and a received signal strength indicator level of the control signal. Handset 2 in a standby state determines whether handset 2 is located in an area where communication is performed at high power or an area where communication is performed at low power from the recognized propagation loss.

Handset 2 transmits the notification message for power control to base unit 1 at predetermined time intervals (about 5 minutes). Further, handset 2 transmits the notification message for transmission power control to base unit 1 at a predetermined event, for example, when handset 2 is removed from a charging cradle, when handset 2 moves between a low power communication area and a high power communication area, or when a sensor responds. At this time, the notification message for transmission power control from handset 2 is transmitted to base unit 1 using Mt:escape of one slot without delivery confirmation. Further, the number of times of retransmission at that time is adjusted according to the type or importance of the event.

When moving between the low power communication area and the high power communication area, handset 2 transmits the notification message for transmission power control to base unit 1. Upon reception of a radio signal which includes the notification message transmitted from each of handset 2, base unit 1 measures a received signal strength indicator level of the signal and stores the received signal strength indicator level for each handset 2 as shown in FIG. 9. Base unit 1 calculates a propagation loss between base unit 1 and each handset 2 and determines a transmission power value of the control signal so as to suit handset 2 having the largest propagation loss. Base unit 1 informs each handset 2 of information of the transmission power value on the control signal. For example, when at least one handset 2 is located in the high power communication area, base unit 1 also sets the transmission power value to high power to transmit the control signal.

That is, base unit 1 calculates the propagation loss between base unit 1 and each handset 2 by information indicating the transmission power value notified in the notification message from each handset 2 and the received signal strength indicator level at the time when the notification message is received. Base unit 1 determines the transmission power value of base unit 1 so as to support handset 2 with which there is a largest propagation loss (located the farthest or located in an environment where it is difficult for a radio wave to reach), and informs handset 2 of information indicating the transmission power value using a Pt message in field A and a MBn message in field B of the control signal.

It should be noted that it is desirable to prohibit handset 2 from switching to low power for a given period of time after switching to high power in order to prevent frequent switching of power at an area boundary. In this case, switching from low power to high power is performed instantaneously.

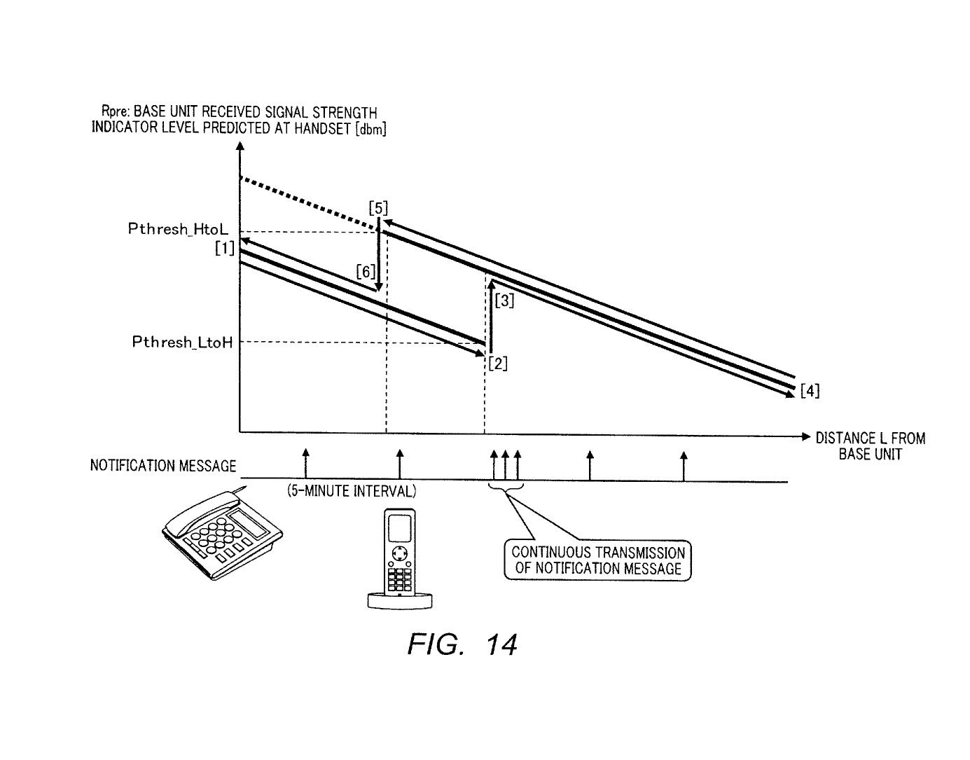

FIG. 14 explains a relationship between a propagation loss and a distance when handset 2 switches from low power to high power and from high power to low power, and a timing of the notification message to be transmitted from handset 2 to base unit 1.

FIG. 14 shows a base unit received signal strength indicator level (dbm) predicted at handset 2 on the vertical axis and shows a distance between base unit 1 and handset 2 on the horizontal axis. Pthresh HtoL is a threshold of the predicted received signal strength indicator level value at base unit 1 for allowing handset 2 which performs transmission at high power to switch to low power. Pthresh LtoH is a threshold of the predicted received signal strength indicator level value at base unit 1 for allowing handset 2 which performs transmission at low power to switch to high power. Handset 2 calculates a signal attenuation value between handset 2 and base unit 1 (corresponding to a distance therebetween) in a standby state based on information indicating the transmission power value of base unit 1 transmitted from base unit 1 on the control signal and a measured value of an actual received signal strength indicator level of the signal from base unit 1.

Handset 2 obtains a predicted value:Rpre of the above-described received signal strength indicator level of base unit 1 based on the calculation result and the transmission power value of base unit 1 at that time. For example, the following expression (6) indicates a predicted value:Rpre(low) of the received signal strength indicator level of base unit 1 when handset 2 enters the low power state:

Rpre(low)=Plow−(Pftx−Pprx) (Expression 6)

Pftx: transmission power value of base unit signal

Pprx: received signal strength indicator level of base unit signal at handset

Plow: transmission power value of handset in low power state

Further, the following expression (7) indicates a predicted value:Rpre(hi) of a received signal strength indicator level of base unit 1 when handset 2 enters the high power state:

Rpre(hi)=Phigh−(Pftx−Pprx) (Expression 7)

Pftx: transmission power value of base unit signal

Pprx: received signal strength indicator level of base unit signal at handset

Phigh: transmission power value of handset in high power state

In the example of FIG. 14, when handset 2 which performs transmission at low power moves in a direction away from the vicinity of base unit 1, the transmission power value of handset 2 is switched from low power to high power at a predetermined time point. That is, a predicted value of a received signal strength indicator level of base unit 1 calculated at handset 2 which moves away from the vicinity of base unit 1 changes from (1) to (2), and, when this predicted value of the received signal strength indicator level reaches Pthresh LtoH, handset 2 switches the transmission power value from low power to high power ((2) to (3)). After that, if handset 2 further moves in a direction away from the vicinity of base unit 1, the predicted value of the received signal strength indicator level of base unit 1 changes from (3) to (4).

In contrast, when handset 2 moves in a direction which approaches base unit 1 from a position distant from base unit 1, the transmission power value of handset 2 is switched from high power to low power. That is, the predicted value of the received signal strength indicator level of base unit 1 calculated at handset 2 changes from (4) to (5) in FIG. 14, and when this predicted value of the received signal strength indicator level reaches Pthresh HtoL, handset 2 switches the transmission power value from high power to low power. If handset 2 further moves in a direction which approaches base unit 1, the predicted value of the received signal strength indicator level of base unit 1 changes from (6) to (1).

That is, handset 2 switches to high power when handset 2 enters the state corresponding to the following expression (8) while performing transmission at low power:

Rpre(low)<Pthresh LtoH (Expression 8)

Further, handset 2 switches to low power when handset 2 enters the state corresponding to the following expression (9) while performing transmission at high power:

Rpre(hi)>Pthresh HtoL (Expression 9)

Here, Pthresh HtoL is set sufficiently higher than Pthresh LtoH. By setting in this manner, when handset 2 performs transmission at high power, handset 2 can switch to low power when the predicted value Rpre(hi) of the received signal strength indicator level of the base unit at the time of high power becomes sufficiently high in the course of handset 2 approaching base unit 1. By providing a threshold for switching from high power to low power and a threshold for switching from low power to high power separately in this way, it is possible to prevent frequent occurrence of switching of the transmission power value near a boundary between the low power and the high power.

It should be noted that, as shown in FIG. 14, when handset 2 transmits the notification message for transmission power control to base unit 1 at predetermined time intervals (about 5 minutes), handset 2 uses Mt:escape of one slot without delivery confirmation. The notification message for transmission power control transmitted to base unit 1 by handset 2 indicates the transmission power value of handset 2 at that time ((2) to (3)). Handset 2 continuously and repeatedly transmits the notification message for transmission power control, and the number of times of retransmission is approximately three. Further, the number of times of retransmission is adjusted according to the type or importance of the event.

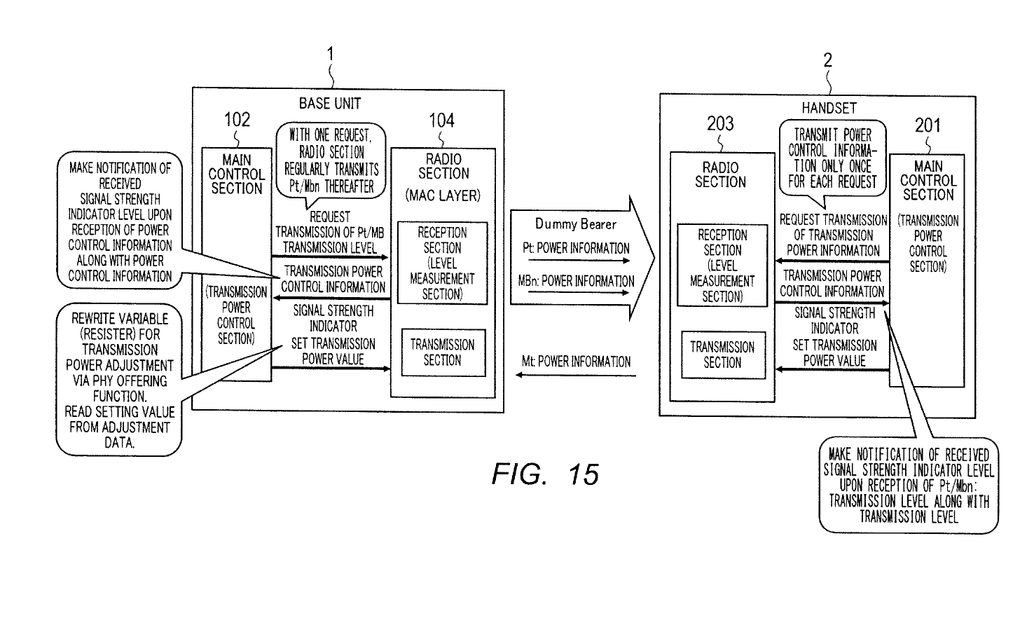

FIG. 15 explains notification of the notification message for transmission power control while base unit 1 and handset 2 are in the transmission standby state.

Handset 2 is notified of transmission power value of base unit 1 using a control signal (Dummy Bearer) to be transmitted as a control signal, and a message for notification is transmitted using a Pt message (RFP power level) in a MAC layer defined in the DECT standard. Further, as a transmission method, Connectionless Bearer (Long), which uses field B of the control signal (Dummy Bearer) and does not require delivery confirmation is used. Base unit 1 transmits the Pt message to handset 2 on Connectionless Bearer.

As with a handset for telephone among a plurality of types of handsets, with respect to the type of the handset which waits for field A of a frame at 640-msec intervals and having a frame number of 0 (hereinafter, referred to as a field A waiting handset), base unit 1 makes notification of the transmission power value using the Pt message to be transmitted and received in field A.

Handset 2 in FIG. 15 is a field A waiting handset. An interval and timing for transmitting the Pt message for notifying the field A waiting handset of the transmission power value are determined by the MAC layer. The determined Pt message is scheduled along with other Pt messages and transmitted at regular time intervals.

It should be noted that with respect to a handset which waits for field B having a specific frame number according to a system as with a handset with a camera function (hereinafter, referred to as a field B waiting handset), the transmission power value is notified using MAC layer B-field messages to be transmitted and received in field B. An interval and timing for transmitting the MAC layer B-field messages which notifies the field B waiting handset of the transmission power value are designated by the transmission power control section. The MAC layer transmits the messages in accordance with the designated transmission interval and timing.

Radio section 203 of handset 2 receives information indicating the transmission power value of base unit 1 which is transmitted using the Pt message (RFP power level) of the MAC layer from base unit 1. Radio section 203 of handset 2 notifies main control section 201 of the received information along with the received signal strength indicator level when the Pt message is received. Further, upon reception of information indicating the transmission power value of base unit 1 transmitted from base unit 1 using MBn:escape, radio section 203 also notifies main control section 201 of the information along with the received signal strength indicator level when the MBn:escape is received. Main control section 201 updates the handset side transmission power control table shown in FIG. 10 according to these pieces of information.

When it is necessary to transmit the information indicating the transmission power value at handset 2, main control section 201 instructs radio section 203 to transmit the information to base unit 1 only once. Radio section 203 transmits the notification message including the information for power control which can be completed in one slot to base unit 1 using Mt:escape.

Radio section 104 of base unit 1 notifies main control section 102 of information indicating the transmission power value of handset 2 for the notification message transmitted using Mt:escape from handset 2 along with the signal received signal strength indicator level of the notification message. Main control section 102 updates the base unit side transmission power control table shown in FIG. 9 according to these pieces of information.

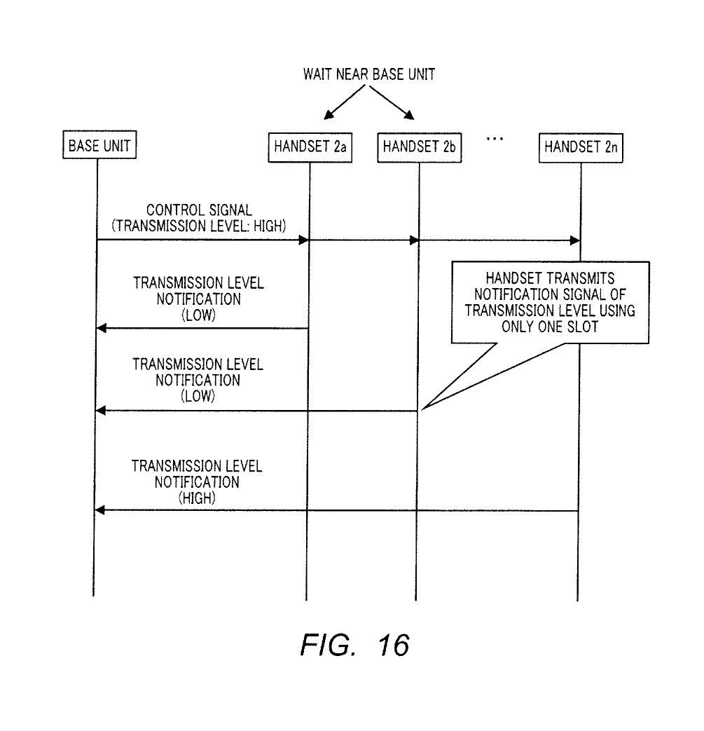

It should be noted that notification of the transmission power value from handset 2 to base unit 1, which also serves as confirmation as to whether handset 2 is alive, is performed using a signal called Connectionless Bearer (short) during a standby state, which does not require delivery confirmation as with the method described above. FIG. 16 is a timing chart showing that a plurality of handsets (handset 2a, handset 2b . . . , handset 2n) transmit notification messages for transmission power control to base unit 1 at predetermined time intervals.

Main control section 201 (a transmission power control section) of each handset transmits the notification message for transmission power control to base unit 1 at predetermined time intervals (about 5 minutes) as shown in FIG. 16, in addition to making notification of the transmission power value when the handset moves between the high power communication area and the low power communication area. In a handset like a handset for telephone, which operates while the power supply of a CPU is in the onstate, main control section 201 (the transmission power control section) makes notification of the transmission power value at regular time intervals using a timer, or the like. Further, in a handset like a handset with a camera function, in which the power supply of a CPU is turned off by ULE control during intermittent reception, main control section 201 (the transmission power control section) makes notification of the transmission power value by being triggered by reception of an alive confirmation request from base unit 1. In this way, by making notification for transmission power control at predetermined time intervals, the procedure of the transmission power control can also serve as confirmation as to whether the handset is alive.

Operation in a case where it becomes necessary to transmit information indicating the transmission power value at handset 2 will be described in detail next. When it becomes necessary to transmit the information indicating the transmission power value in a standby state, main control section 201 selects a slot/frequency which is predicted to be used for transmission of the control signal and performs carrier sensing on two successive slots starting from the selected slot. Upon reception of the control signal (Dummy Bearer) transmitted from base unit 1, main control section 201 determines one slot having a predetermined relationship with respect to the slot in which the control signal is received as a transmission slot based on the information obtained from the signal. That is, a slot used by handset 2 to perform transmission is determined to match the timing of Primary receiver Scan of base unit 1.

Main control section 201 of handset 2 transmits the notification message for transmission power control which can be completed in one slot using a transmission slot whose timing is made to match the timing of Primary receiver Scan of base unit 1. That is, main control section 201 of handset 2 transmits Mt:escape for making notification of information indicating the transmission power value of handset 2 at that time.

During communication, notification of the transmission power value from handset 2 to base unit 1 is performed using a communication channel (Traffic Bearer). Further, also upon transmission of Mt:access request when handset 2 activates the communication channel (Traffic Bearer), the notification message for transmission power control is transmitted to base unit 1 using the signal (Connectionless Bearer(short)) which can be completed in one slot in a similar manner.

Note that also when it becomes necessary to transmit the information indicating the transmission power value during a call, handset 2 transmits the notification message for transmission power control to base unit 1 using the signal (Connectionless Bearer(short)) which can be completed in one slot. In this case, handset 2 makes notification of the information indicating the transmission power value by transmitting Mt:escape using field A of Traffic Bearer which is communicating.

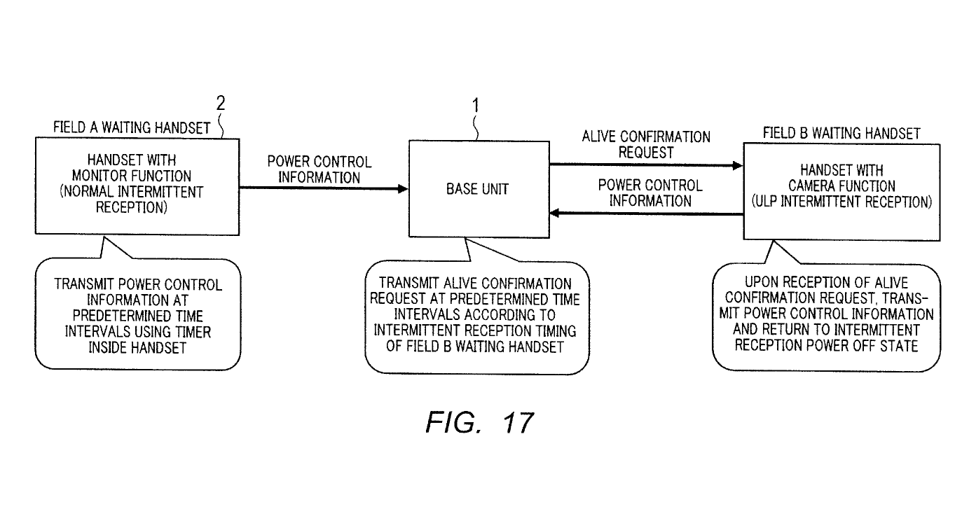

FIG. 17 explains a case where the notification message for the transmission power value is utilized to confirm whether or not the handset is alive (monitor whether or not the handset is alive) during a standby state. Base unit 1 monitors whether or not the handset is alive through regular confirmation as to whether or not the handset is alive by performing communication between base unit 1 and handset 2 in order to detect a communication failure due to interference.

As described above, handset 2 transmits the notification message for transmission power control at regular time intervals. When base unit 1 cannot receive the notification message from handset 2 within a time limit, base unit 1 stops transmission power control of base unit 1 and switches the transmission power value to a maximum value (high power).

Specifically, as shown in FIG. 17, handset 2 (a field A waiting handset such as a telephone handset) which does not perform intermittent reception of ULE is in synchronization with base unit 1 also during a sleep state. Such handset 2 transmits the notification message for transmission power control at regular time intervals (about every 5-minute interval) by a timer function of main control section 201 of handset 2. Base unit 1 can confirm that handset 2 is alive by receiving this notification message.

Further, base unit 1 transmits an alive confirmation request at predetermined time intervals so as to match an intermittent reception timing of a handset (a field B waiting handset such as a handset with a camera function) which performs intermittent reception of ULE. This alive confirmation request takes on a role of encouraging handset 2 which performs intermittent reception of ULE to transmit the information for transmission power control.

Handset 2 which performs intermittent reception of ULE performs operation for searching base unit 1 by activating radio section 203 in accordance with a time when base unit 1 starts transmission of the alive confirmation request. Upon reception of a control signal transmitted from base unit 1, handset 2 receives the alive confirmation request transmitted from base unit 1 and transmits the notification message for transmission power control using the reception as a trigger. Alternatively, when the alive confirmation request is included in the control signal issued by base unit 1, handset 2 confirms the alive confirmation request from base unit 1 upon reception of the control signal and transmits the notification message for transmission power control.

It should be noted that handset 2 which performs intermittent operation of ULE stops reception operation of radio section 203 in a sleep state between time intervals of the intermittent operation. Further, because the timer function of main control section 201 of handset 2 does not work either, base unit 1 transmits the alive confirmation request in accordance with an intermittent reception timing of handset 2.

When a notification message for transmission power control cannot be received from given handset 2 for a fixed period of time (an adjusted value) or longer, main control section 102 (the transmission power control section) of base unit 1 switches the transmission power value of base unit 1 to high power. Then, if a notification message cannot be received from handset 2 for an additional fixed period of time (an adjusted value), if handset 2 is a field A waiting handset such as a handset for telephone and a handset with an image monitor function, handset 2 of base unit 1 is excluded from a calculation target of transmission power control. It should be noted that in the operation of transmitting an alive confirmation request from base unit 1 to handset 2, base unit 1 retransmits the request the number of times designated by the adjusted value.

Note that when the power supply of handset 2 has sufficient capacity, main control section 201 (the transmission power control section) of handset 2 may perform operation of searching for the notification message for transmission power control from base unit 1 for a fixed period of time, and may switch the transmission power value of handset 2 to high power when the notification message cannot be received for a fixed period of time (a fixed value: approximately 10 minutes) or longer.

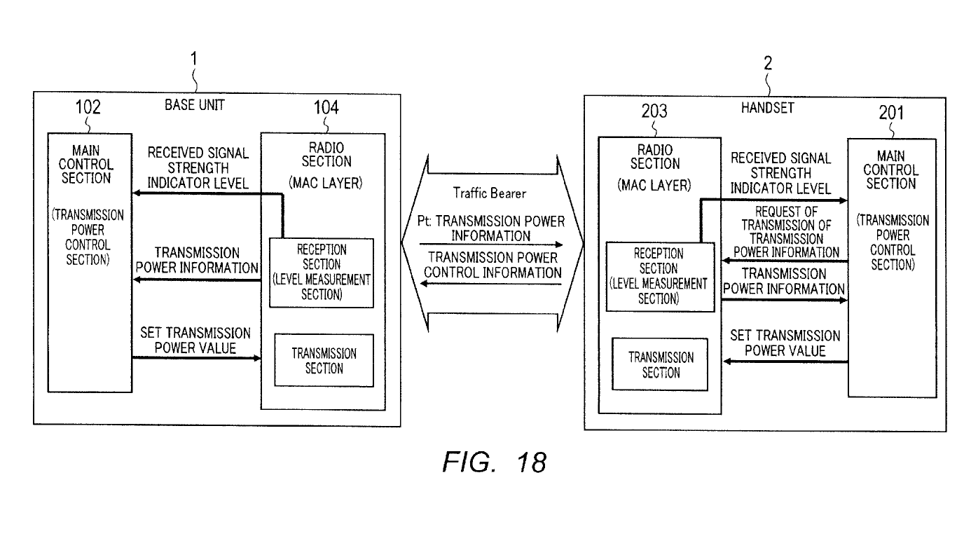

FIG. 18 explains transmission power control in a call channel during a call. In the transmission power control in the communication channel (Traffic Bearer) during a call, information indicating a transmission power value is exchanged using the notification message for a received signal strength indicator level of the call channel and for transmission power control.

When the communication channel (Traffic Bearer) is activated by start of calling, MAC layers of base unit 1 and handset 2 regularly notify upper layers of a received signal strength indicator level of the communication channel (Traffic Bearer). As a result, the transmission power control sections are notified of the information of the received signal strength indicator level via the upper layers. For example, main control section 102 (the transmission power control section) of base unit 1 switches the transmission power value of base unit 1 according to the notified received signal strength indicator level. The information indicating the transmission power value from base unit 1 during a call is notified using the Pt message of field A of the communication channel (Traffic Bearer). That is, base unit 1 transmits the same message as the Pt message to be transmitted using the field A of the control signal (Dummy Bearer), using field A of the communication channel (Traffic Bearer). Base unit 1 transmits the information of the transmission power value of base unit 1 to handset 2 on this field A.

Further, main control section 201 (the transmission power control section) of handset 2 switches the transmission power value of handset 2 every time information indicating the measured value of the received signal strength indicator level is received from radio section 203 and transmits the information indicating the latest transmission power value of handset 2 to base unit 1. In this way, by transmitting the notification message for transmission power control by being triggered by obtaining the information of the received signal strength indicator level, base unit 1 is notified of the notification message for transmission power control at short time intervals during communication also with respect to handset 2 which supports intermittent operation of ULE, like a handset with a camera function or a handset with a sensor. Accordingly, base unit 1 does not necessarily have to request for transmission of the notification message for transmission power control at the time of starting communication. That is, base unit 1 only has to transmit the notification message for transmission power control when the transmission power value is switched during communication.

There are the following operation patterns for detection of a received signal strength indicator level during communication.

Upon reception of information indicating the transmission power value of handset 2 using Mt:escape from handset 2, the MAC layer of base unit 1 notifies main control section 102 of a received signal strength indicator level at the time when Mt:escape is received. Further, when the communication channel (Traffic Bearer) is activated, the MAC layer of base unit 1 notifies main control section 102 of a received signal strength indicator level of the communication channel at regular time intervals.

Note that, when old type handset 2 which has no support for transmission power control yet is registered, the information indicating the transmission power value of handset 2 is not received from handset 2 using Mt:escape. In this case, base unit 1 controls the transmission power value of base unit 1 while detecting a received signal strength indicator level of the communication channel at regular time intervals.

Further, also when the information indicating the transmission power value of handset 2 is received from handset 2 using Connectionless Bearer(Long), the MAC layer of base unit 1 notifies main control section 102 of base unit 1 of a received signal strength indicator level obtained upon reception of Connectionless Bearer(Long).

When field A waiting handset (which waits for field A of a predetermined frame at 640-msec intervals) 2 is a communication counterpart, handset 2 is excluded from a calculation target of transmission power control if base unit 1 cannot receive a notification message for a fixed period of time (for example, 24 hours) or longer. Here, examples of the field A waiting handset include a handset for telephone and a handset with a monitor function. By excluding handset 2 from which base unit 1 cannot receive a notification message for a long time from the calculation target of transmission power control, even if handset 2 completely stops operation, base unit 1 can perform transmission power control while ignoring handset 2.

Further, also in handset 2, when the communication channel (Traffic Bearer) is activated, the MAC layer notifies main control section 201 of a received signal strength indicator level of the communication channel (Traffic Bearer) at regular time intervals. When the communication counterpart is old type base unit 1 which has no support for transmission power control yet, the information indicating the transmission power value is not received from base unit 1 using Mt:escape. Therefore, handset 2 controls the transmission power value of handset 2 while detecting a received signal strength indicator level of the communication channel (Traffic Bearer) at regular time intervals.

Note that, handset (the field B waiting handset) 2 which performs intermittent reception of ULE, like a handset with a camera function and a handset with a sensor is required to reliably convey detection information to base unit 1, so that, even if a received signal strength indicator level is low, it is impossible to ignore handset 2. Therefore, such handset 2 is not excluded from the calculation target of transmission power control even if a notification message cannot be received for a fixed period of time (the adjusted value) or longer. This will be described in detail later.

Next, an example of operation of the above-described wireless communication apparatus will be described. FIG. 19 is a flowchart showing an example where handset 2 operates in synchronization with base unit 1.

First, in FIG. 19, when operation is started by power being supplied to base unit 1, a standby mode is activated. In step (hereinafter, abbreviated as “ST”) 101, base unit 1 starts transmission of a control signal. Further, in ST102, base unit 1 starts operation of receiving a response signal from each handset 2 in a slot for reception having a relationship of a predetermined temporal position with respect to a slot used for transmitting the control signal. Note that base unit 1 transmits the control signal with synchronization information and information of the transmission power value of base unit 1 in the control signal.

In ST201, when a power supply switch (not shown) of handset 2 is turned on, power is also supplied to main control section 201 and each section. Main control section 201 starts reception operation for continuously searching (open search) signals from base unit 1 by issuing an instruction to radio section 203. Further, in ST202, main control section 201 activates a first timer for open search and a second timer for controlling periodic communication operation using timer section 201b which counts a clock.

In ST203, when the control signal from base unit 1 is received at radio section 203 (ST203: YES), the flow proceeds to ST205. When a control signal is not received from base unit 1 (ST203: NO), the flow proceeds to ST204.

In ST204, main control section 201 determines whether or not the second timer for open search has expired. As a result of determination in ST204, if the second timer has not expired (ST204: NO), the flow returns to ST203. Meanwhile, as a result of determination in ST204, if the second timer has expired (ST204: YES), the flow proceeds to ST212, where a message of “base unit 1 cannot be confirmed” is displayed. Then, in ST217, main control section 201 turns off the communication function and shifts to a sleep state.

In ST218, main control section 201 determines whether or not the first timer for intermittent operation has expired. The first timer expires once every about 5 minutes. When the first timer has not expired (ST218: NO), the sleep state is maintained until the first timer expires. When the first timer has expired (ST218: YES), the flow returns to ST201, where communication operation is started, and reception operation for continuously searching signals from base unit 1 is started.

Operation for transmitting the notification message from handset 2 to base unit 1 will be described below.

In ST203, if the control signal from base unit 1 is received at radio section 203 (ST203: YES), in ST205, main control section 201 acquires the synchronization information transmitted using the control signal. In ST206, main control section 201 establishes TDMA synchronization with base unit 1 according to the synchronization information, and enters the synchronization state while receiving the control signal from base unit 1. In ST207, main control section 201 displays that communication using DECT is possible. During a standby state, handset 2 maintains the synchronization state while receiving the control signal (Dummy Bearer) from base unit 1 as shown in FIG. 15.

Base unit 1 puts information of the transmission power value of base unit 1 in addition to the information for synchronization in the control signal to be transmitted as described above. When handset 2 enters the synchronization state, in ST208, main control section 201 starts execution of regular handset side transmission power determination procedure.

In the handset side transmission power determination procedure in ST208, main control section 201 extracts information indicating the transmission power value of base unit 1 transmitted using the control signal from base unit 1 as shown in FIG. 15. Further, main control section 201 measures a received signal level of the control signal from base unit 1. Main control section 201 records (or updates) the transmission power value of base unit 1 and the measured value of the received signal level in the handset side transmission power control table provided in memory section 202. Further, main control section 201 obtains a propagation loss from the transmission power value of base unit 1 and the measured value of the received signal level, and records (or updates) the values in the handset side transmission power control table provided in memory section 202.

In ST209, main control section 201 determines the transmission power value of handset 2 and notifies base unit 1 of the transmission power value. Further, main control section 201 notifies base unit 1 of other various necessary notification messages, for example, error information.

In ST210, in a case where some event occurs in handset 2 at that time, main control section 201 transmits a response signal, or the like. Examples of the case where some event occurs include a case where a user of handset 2 performs operation for originating a call and a case where information indicating that there is an incoming call from a fixed line network is transmitted using the control signal from base unit 1. Further, also in a case where a sensor or the like provided at handset 2 gives some response, main control section 201 transmits information regarding the event to base unit 1.

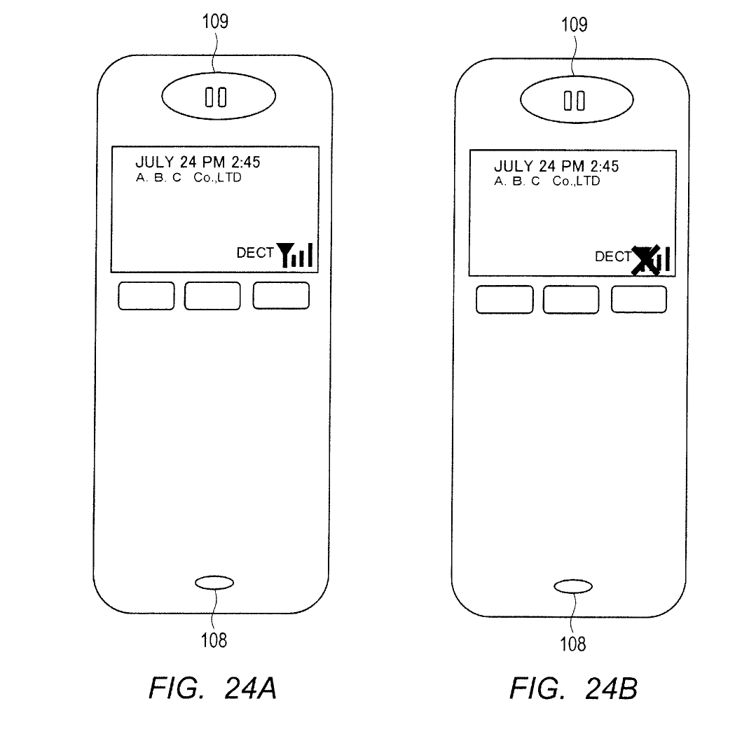

In ST211, when main control section 201 cannot receive a control signal from base unit 1 (ST211: NO), the flow proceeds to the above-described ST212. In ST211, main control section 201 determines that communication using DECT becomes impossible, and displays that “no DECT connection” at display section 205. For example, as shown in FIG. 24B, a cross mark is displayed over an antenna mark adjacent to the character “DECT.”

When the control signal can be received from base unit 1 at main control section 201 (ST211: YES), the flow proceeds to ST213. In ST213, main control section 201 determines whether or not the first timer for intermittent operation has expired. If the first timer has not expired (ST213: NO), the flow proceeds to ST211. As a result, main control section 201 continues monitoring of the control signal from base unit 1. In ST213, if the first timer has expired (ST213: YES), the flow proceeds to ST214.

In ST214, main control section 201 executes the handset side transmission power determination procedure as in ST208 described above. Further, main control section 201 extracts information indicating the transmission power value of base unit 1 transmitted using the control signal from base unit 1 and measures a received signal level of the control signal from base unit 1. Main control section 201 updates the handset side transmission power control table provided in memory section 202 using the transmission power value of base unit 1 and the measured value of the received signal level.

Further, main control section 201 determines the transmission power value of handset 2 in ST215 to notify base unit 1 of the transmission power value and notifies base unit 1 of other various necessary notification messages.

In ST216, in a case where some event occurs at handset 2 at that time, main control section 201 transmits information regarding the event to base unit 1. The case where some event occurs includes, for example, a case where the user performs operation for originating a call, a case where response operation for an incoming call is performed, a case where the handset is removed from the charging cradle, and a case where a sensor of the handset performs detection. It should be noted that, though not shown, if a voice call is started via a fixed line network, main control section 201 transmits and receives voice data to and from base unit 1 using one slot each for uplink and downlink.

It should be noted that in ST103, base unit 1 receives a notification message regarding the event from handset 2. If there is an incoming call from the fixed line network, base unit 1 transmits incoming call information to handset 2. If a voice call is started via the fixed line network, base unit 1 transmits and receives voice data to and from handset 2 using one slot each for uplink and downlink.

In ST104, base unit 1 constantly performs base unit side transmission power determination procedure. In the base unit side transmission power determination procedure, main control section 102 extracts information indicating the transmission power value of handset 2 transmitted using the notification message from handset 2. Further, level measurement section 104a measures a received signal level of the notification message from handset 2. Main control section 102 records (or updates) the information indicating the transmission power value of handset 2 and the measured value of the received signal level in the base unit side transmission power control table provided in memory section 103 for each handset based on the information.

Further, base unit 1 recognizes a state of handset 2, receives, for example, information regarding the event or other various notification messages (such as error information) transmitted from handset 2 and records the information in the table.

In ST105, base unit 1 determines the transmission power value of base unit 1 and notifies handset 2 of the transmission power value.

In ST106, base unit 1 determines whether or not there are responses from all registered handsets 2 in response to the requests from base unit 1. If there is handset 2 that does not respond to the request from base unit 1 (ST106: NO), the flow proceeds to ST107. In ST107, base unit 1 updates information of a handset state management section of a registration information recording section of memory section 103, and sets a flag indicating that “there is no response” for handset 2. In ST108, base unit 1 maximizes the transmission power. Meanwhile, if there are responses from all handsets 2 in response to the requests from base unit 1 (ST106: YES), the flow returns to ST101.

In this way, handset 2 performs communication in synchronization with base unit 1 within a range where signals from both sides can reach. If handset 2 moves away from base unit 1 and the received signal level of the control signal from base unit 1 decreases and a propagation loss of the table of memory section 103 decreases to a predetermined value or lower, base unit 1 transmits a signal with maximum power.

It should be noted that in ST211, if the control signal cannot be correctly received from base unit 1, main control section 201 displays that “no DECT connection” in display section 205 as described above, turns off the communication function and shifts to a sleep state (ST217). In ST218, it is determined whether or not the first timer for intermittent operation has expired, and if the first timer has not expired (ST218: NO), the sleep state is maintained until the first timer expires.

If the first timer has expired (ST218: YES), the flow returns to ST201, where communication operation is started. That is, if the control signal from base unit 1 cannot be correctly received, intermittent reception operation is performed at about 5-minute intervals at which the first timer expires.

In this way, if handset 2 is out of a coverage area where a signal is receivable, or if a signal from base unit 1 cannot be correctly received for some reasons, main control section 201 of handset 2 does not continuously search base unit 1. Instead, main control section 201 of handset 2 is switched to an intermittent communication mode in which main control section 201 is activated at time intervals specified by the first timer and enters the sleep state after searching base unit 1.

Note that in the above-described examples, handset 2 performs operation of searching for base unit 1 at about 5-minute intervals specified by the first timer after handset 2 cannot communicate with base unit 1. However, handset 2 may change the time intervals to longer time intervals after a predetermined period elapses.

That is, handset 2 searches for base unit 1 at predetermined time intervals (first predetermined time intervals) specified by the first time after handset 2 cannot communicate with base unit 1. Then, after the subsequent predetermined period elapses, handset 2 changes an expiration value of the first timer and sets an expiration value (second predetermined time intervals) longer than the first predetermined time intervals to the first timer.

As described above, according to the present embodiment, even if a plurality of handsets 2 (for example, handset 2a, handset 2b and handset 2c) are registered to base unit 1, base unit 1 calculates a propagation loss between base unit 1 and each handset 2 based on a transmission power value of each handset 2 and a received signal strength indicator level of the notification message from each handset 2. Base unit 1 determines the transmission power value of base unit 1 that is appropriate for handset 2 which is located farthest. Accordingly, even if given handset 2 moves far away from base unit 1, base unit 1 can transmit the control signal at a minimal necessary transmission power value which allows communication to be maintained with handset 2. By this means, base unit 1 can maintain communication with all handsets 2 while minimizing radio wave interference to another radio communication system.

Handset 2 calculates a propagation loss between handset 2 and base unit 1 from the received signal strength indicator level of the control signal from base unit 1 and the transmission power value of base unit 1, determines the transmission power value of handset 2 and updates the information of the handset side transmission power control table. Handset 2 regularly notifies base unit 1 of the transmission power value stored in the information of the handset side transmission power control table. By this means, it is possible to increase the life of a battery by avoiding power consumption of handset 2 and minimize radio wave interference to another radio communication system.

Handset 2 transmits the notification message including the information indicating the transmission power value of handset 2 to base unit 1 at regular time intervals (for example, 5 minutes) during a standby state. In addition, even when given handset 2 moves and a notification message from the handset cannot reach base unit 1 with a sufficient level, handset 2 switches the transmission power value to high power and transmits a temporary notification message including the information indicating the transmission power value of handset 2 immediately after that. In this way, the notification message regularly transmitted from handset 2 and the temporary notification message enable base unit 1 to increase the transmission power value of base unit 1 according to the notification message from handset 2 before base unit 1 cannot recognize handset 2.

It should be noted that in a case where a call is originated from base unit 1, or in a case where a call is originated from handset 2, handset 2 transmits a request for starting communication to base unit 1, and base unit 1 transmits a reception signal of the request for starting communication to handset 2 in response to the request for starting communication. Handset 2 measures a received signal strength indicator level of the received signal.

Further, when there is no notification message from handset 2 for a fixed period of time, base unit 1 switches the transmission power value of base unit 1 to high power. With this control, when handset 2 cannot transmit a notification message to base unit 1 for some reasons such as because there is no free wireless resource, base unit 1 switches the transmission power value to high power after a fixed period of time has elapsed. Accordingly, for example, even in a state where base unit 1 operates at low power and handset 2 moves away from base unit 1 while maintaining low power and moves to an area in which transmission should be performed at high power, it is possible to reduce a risk of a state where base unit 1 cannot recognize handset 2 (a state where handset 2 is out of the coverage area).

If there is no notification message from given handset 2 for a fixed period of time or longer, base unit 1 performs control to determine the transmission power value while ignoring the handset. By this means, if given handset 2 enters an unused state for reasons such as a failure or loss, base unit 1 can switch the transmission power value to suit another handset 2 while ignoring handset 2 without eliminating registration of handset 2.

Further, if handset 2 is provided with a ULE function, handset 2 transmits a notification message for notifying base unit 1 of the transmission power value using only one slot without forming a normal radio link, which makes it possible to reduce power consumption of handset 2 and wasteful use of radio resources required for notifying base unit 1 of the transmission power value of handset 2.

The operation until transmission power control of both handset 2 and base unit 1 starts while handset 2 is in synchronization with base unit 1 in Embodiment 1 has been described above.

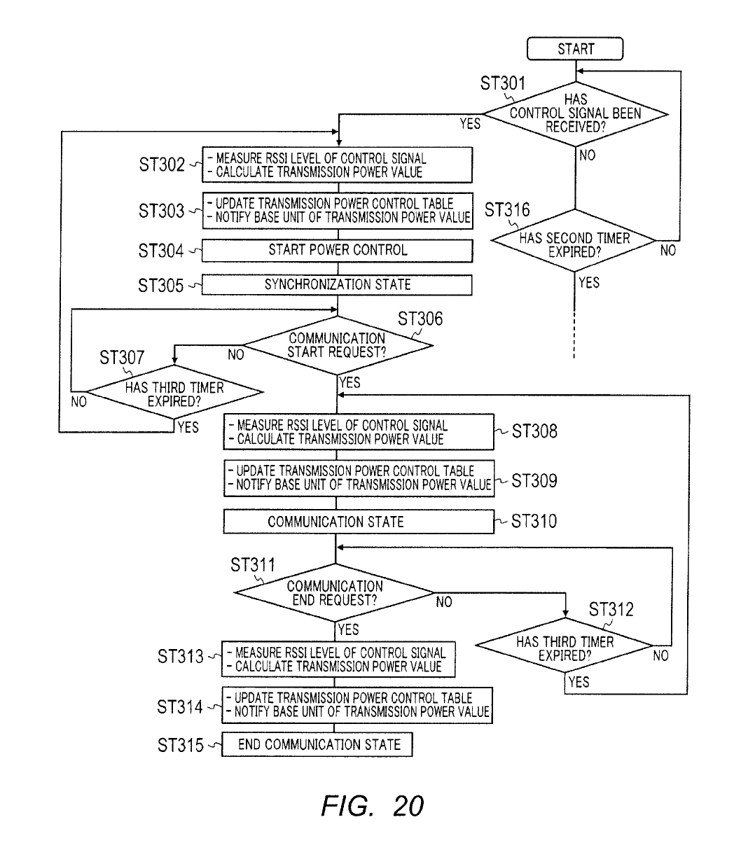

Next, a transmission power control procedure of handset 2 will be described in detail using FIG. 20.

As shown in FIG. 20, in ST301, handset 2 executes open search for receiving a control signal to be transmitted from base unit 1. If the control signal from base unit 1 is received (ST301: YES), the flow moves to ST302. If the control signal from base unit 1 is not received (ST301: NO), the flow moves to ST316. In step ST316, handset 2 determines whether or not the second timer for open search has expired as described above. If the second timer has not expired (ST316: NO), the flow returns to ST301.

In ST302, handset 2 measures a received signal strength indicator level of the control signal. Further, handset 2 determines a propagation loss based on the measured value of the received signal strength indicator level and the transmission power value of base unit 1 transmitted on the control signal, and calculates a transmission power value to be used by the handset to perform transmission.

In ST303, handset 2 updates the transmission power value in the handset side transmission power control table stored in memory section 202 of handset 2. Further, handset 2 notifies base unit 1 of the transmission power value using Mt:escape. In ST304, handset 2 starts transmission power control based on the transmission power value in the updated handset side transmission power control table.

In ST305, handset 2 enters the standby state in which handset 2 is in synchronization with base unit 1 while receiving control signals transmitted from base unit 1 every time or regularly at predetermined time intervals.

In ST306, handset 2 determines whether or not there is a communication start request from base unit 1. If there is a communication start request (ST306: YES), the flow moves to ST308. If there is no communication start request (ST306: NO), the flow moves to ST307.

In ST307, handset 2 manages a third timer which specifies time intervals of power control in a state where handset 2 is in synchronization with base unit 1. The third timer is activated at the last update of the handset side transmission power control table and expires when a predetermined period of time elapses. In ST307, handset 2 does not update the handset side transmission power control table until the third timer expires. When the third timer has expired (ST307: YES), the flow returns to ST302. As a result, handset 2 determines a propagation loss based on a received signal strength indicator level of the latest control signal and the transmission power value of the base unit and updates the handset side transmission power control table.

In ST306, handset 2 determines whether or not there is a communication start request. If there is a communication start request (ST306: YES), the flow moves to ST308. As a result, handset 2 determines a propagation loss based on a received signal strength indicator level of the latest control signal and the transmission power value of the base unit at that time and calculates a transmission power value used by the handset to perform transmission. In ST309, handset 2 updates the handset side transmission power control table stored in memory section 202 and notifies base unit 1 of the transmission power value using Mt:escape which is also used during the standby state. In ST310, handset 2 and base unit 1 enter the communication state by forming a channel for performing communication with each other.

In ST311, handset 2 determines whether or not there is a communication end request for ending communication with base unit 1. If there is a communication end request (ST311: YES), the flow moves to ST313. If there is no communication end request (ST311: NO), the flow moves to ST312.

In ST312, handset 2 manages the third timer which specifies time intervals of power control in a synchronization state in a similar manner to ST307 described above. The third timer expires when a predetermined period of time elapses since the last update of the handset side transmission power control table. If the third timer has expired (ST312: YES), the flow returns to ST308. As a result, handset 2 determines a propagation loss based on a received signal strength indicator level of the latest control signal and the transmission power value of the base unit and updates the handset side transmission power control table.

In ST311, handset 2 determines whether or not there is a communication end request. If there is a communication end request (ST311: YES), the flow moves to ST313. As a result, handset 2 calculates a transmission power value based on the received signal strength indicator level of the latest control signal and the transmission power value of the base unit at that time also in this case. In ST314, handset 2 updates the handset side transmission power control table stored in memory section 202 and notifies base unit 1 of the transmission power value using Mt:escape which is also used during the standby state. On that basis, handset 2 ends communication with base unit 1 (ST315).

It should be noted that handset 2 may update information of power control at predetermined time intervals without changing the expiration value of the third timer during communication and the expiration value of the same during the standby state in the handset transmission power control.

As described above, handset 2 measures a received signal strength indicator level of the control signal transmitted from base unit 1, and determines a transmission power value based on the handset side transmission power control table updated with the measured received signal strength indicator level to perform power control. By this means, handset 2 can maintain communication with base unit 1 with minimal necessary power while minimizing radio wave interference to another wireless communication apparatus.

### Embodiment 2

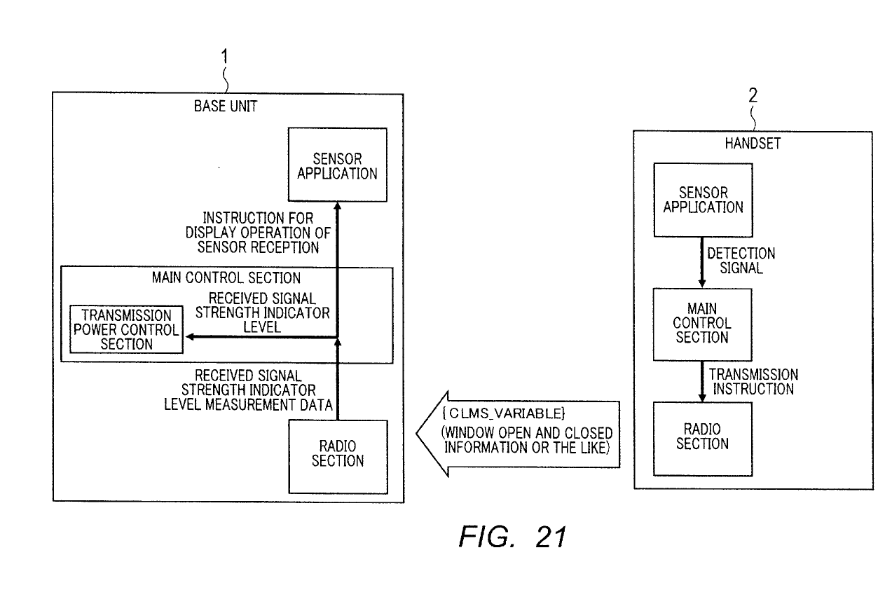

FIG. 21 shows notification of a received signal strength indicator level when sensor information is received from a handset with a sensor in a case where the handset with the sensor which supports ULE intermittent reception is registered in a system. In a case where the handset with the sensor is registered in the system and the handset with the sensor transmits a notification signal (CLMS VARIABLE) including window open and closed information, or the like, base unit 1 controls the transmission power value based on the received signal strength indicator level obtained when this notification message is received.

If the transmission power control section of base unit 1 cannot receive the signal from the handset with the sensor (CLMS VARIABLE) for a fixed period of time (an adjusted value) or longer, the transmission power control section of base unit 1 switches to high power. For a field B waiting handset like such a handset with a sensor, if a signal from the handset with the sensor cannot be received for a fixed period of time (the adjusted value) or longer, the transmission is always made high power without excluding the handset from a calculation target of transmission power control through monitoring as to whether or not the handset is alive.

As described above, a handset which performs intermittent reception of ULE (a field B waiting handset) is not always in synchronization with base unit 1, and does not frequently transmit the received signal strength indicator level to base unit 1. However, it is necessary to reliably convey information detected by the sensor to base unit 1, and even if the received signal strength indicator level is small, the handset cannot be ignored. Accordingly, in a case where a handset which supports intermittent reception of ULE is included in the communication counterpart, even if base unit 1 cannot receive a notification message from the handset for a fixed period of time (the adjusted value) or longer, base unit 1 does not exclude the handset from the calculation target of transmission power control. Further, if a communication situation of the handset improves and the base unit receives Connectionless Bearer(Long) again from the handset, main control section 102 of base unit 1 is notified of the received signal strength indicator level. Base unit 1 performs transmission power control on the calculation target including the handset.

In contrast, for the field A waiting handset such as a handset for telephone as described above, if base unit 1 cannot receive a notification message for a predetermined period of time or longer, base unit 1 excludes the handset from the calculation target of transmission power control, and performs transmission power control with only the transmission power values of other handsets. Meanwhile, base unit 1 performs operation so as to be able to reliably manage an operation state of the handset with the sensor.

### Embodiment 3

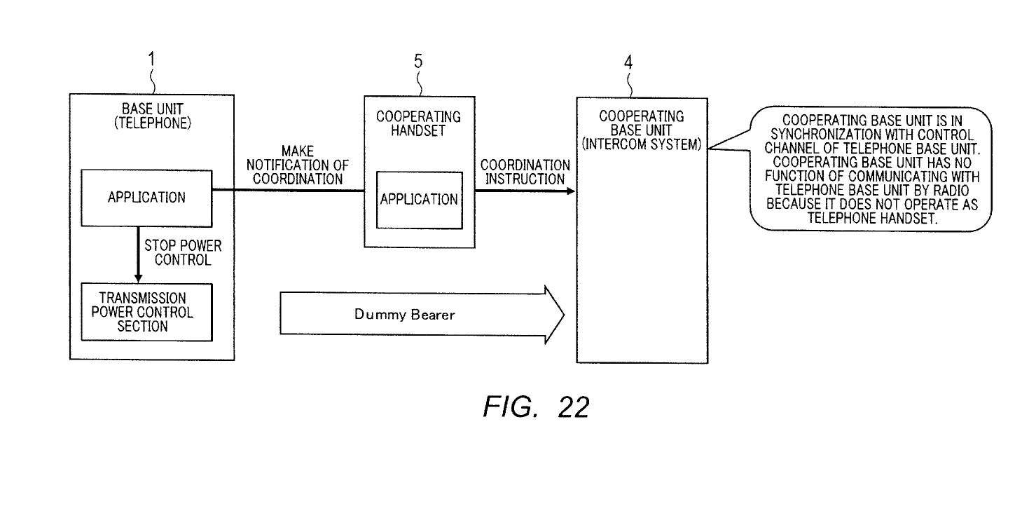

FIG. 22 shows an association in a case where base unit 1 of a cordless telephone and base unit 4 of a radio intercom system cooperate with each other. Cooperating handset 5 is a handset which can be connected to both base unit 1 of the cordless telephone and intercom system base unit 4. In this case, intercom system base unit 4 is not registered in the base unit (hereinafter, referred to as “base unit 1”) of the cordless telephone as a handset.

Intercom system base unit 4 is in synchronization with a channel (a control channel) for transmitting a control signal of base unit 1. Because intercom system base unit 4 does not operate as a handset, intercom system base unit 4 does not have a function of perform radio communication with base unit 1.

In order to make intercom system base unit 4 always operate in synchronization with base unit 1 of the cordless telephone, when intercom system base unit 4 cooperates with base unit 1 of the cordless telephone, base unit 1 stops transmission power control of base unit 1. In this case, an application of cooperating handset 5 notifies an application of base unit 1 that intercom system base unit 4 cooperates with base unit 1 of the cordless telephone. As a result, the application of base unit 1 stops transmission power control.

### Embodiment 4

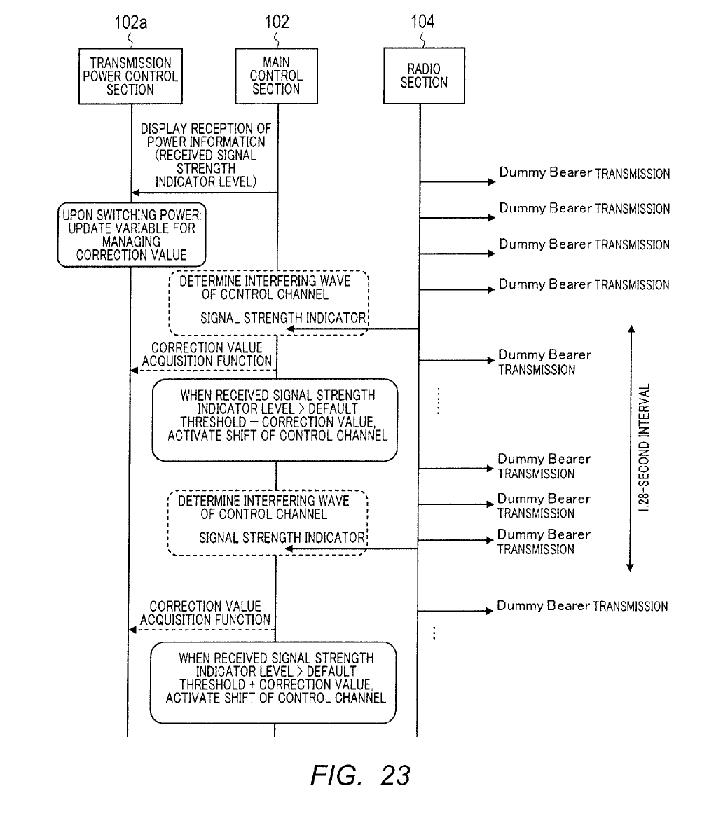

FIG. 23 shows an internal mechanism of a base unit for avoiding interference to another cordless telephone system adjacent to the base unit.

Base unit 1 sets a lower threshold for detecting an interfering wave level of the channel (the control channel) for transmitting the control signal (Dummy Bearer) during operation at low power. Even if only a relatively low interfering wave occurs, base unit 1 activates channel movement for changing the control channel for transmitting the control signal. By this means, it is possible to reduce frequency of occurrence of reception failures in the control channel due to an interfering wave.

Radio section 104 of base unit 1 stops transmission of the control signal at every 1.28-second interval, performs reception operation in a slot for regularly transmitting the control signal, and outputs a measured value of a received signal strength indicator level of the slot to main control section 102. Main control section 102 of base unit 1 determines whether or not there is an interfering wave and intensity of the interfering wave using a threshold based on information of the received signal strength indicator level from radio section 104.

Main control section 102 of base unit 1 corrects the threshold for shifting the control channel according to a transmission power control state. Main control section 102 sets a lower threshold for detecting an interfering wave level for a lower transmission power value of base unit 1, and sets a higher threshold for detecting an interfering wave level for a higher transmission power value of base unit 1. By this means, main control section 102 updates the threshold for detecting an interfering wave level according to a received signal strength indicator level in the control channel.

Main control section 102 outputs a correction value acquisition function to transmission power control section 102a when changing the threshold. Upon reception of information of the received signal strength indicator level from main control section 102, transmission power control section 102a of base unit 1 updates a variable for managing a correction value. By this means, transmission power control section 102a controls the transmission power value of base unit 1. Note that main control section 102 may perform processing of only returning a variable for managing a correction value in order to minimize a processing time.

Main control section 102 of base unit 1 determines whether or not activation of control channel shift is necessary by comparing the interfering wave level in the control channel with the threshold. That is, if the received signal strength indicator level>a default threshold—the correction value is satisfied based on the received signal strength indicator level in the control channel, control channel shift is activated.

### Embodiment 5

Typically, as shown in FIG. 16, a plurality of handsets (handset 2a, handset 2b, . . . , handset 2n) transmit notification messages for transmission power control to base unit 1 at predetermined time intervals (about 5 minutes) by being triggered by reception of an alive confirmation request from base unit 1 at predetermined time intervals.

For example, let us consider a case where a user moves away from a base unit immediately after removing a handset from a charging cradle and originates a call in order to try to make a call which the user does not wish to be heard by others. In this case, if a transmission power value remains low, there is a situation where call-originating operation is performed in a state where communication is impossible between the handset and the base unit. In this situation, it is impossible to immediately establish a radio link between the handset and the base unit.

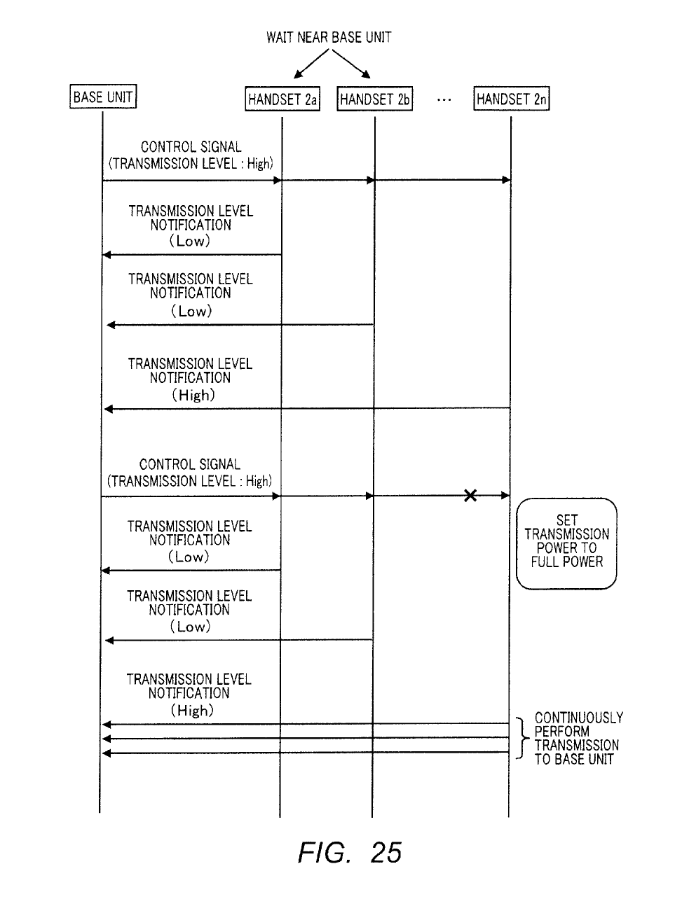

Therefore, in the present embodiment, when a control signal of base unit 1 cannot be correctly received, handset 2 stops transmission power control of handset 2, sets the transmission power value to full power and notifies base unit 1 of information indicating the transmission power value. FIG. 25 shows how given handset 2 notifies base unit 1 of the information indicating the transmission power value of handset 2 when a control signal from base unit 1 cannot be correctly received.

As shown in FIG. 25, if the control signal to be regularly transmitted from base unit 1 cannot be correctly received, or if a received signal strength indicator level of the control signal transmitted from base unit 1 does not reach a predetermined threshold, main control section 201 of given handset 2n sets the transmission power value of handset 2n to full power. Handset 2n then notifies base unit 1 of information indicating the transmission power value of handset 2n at a timing of subsequent transmission. At that time, handset 2n notifies base unit 1 of the information indicating the transmission power value of handset 2n more frequently than normally regardless of the above-described notification timing.

For example, handset 2 transmits a notification message for transmission power control to base unit 1 three times in a row using Mt:escape of one slot without delivery confirmation. The number of times of retransmission at that time is adjusted according to the importance of the function of handset 2.

Further, handset 2 receives the control signal regularly transmitted from base unit 1 and measures a received signal strength indicator level. Even if handset 2 determines that the measured value becomes lower than a reception power reference value, handset 2 notifies base unit 1 of information indicating the transmission power value of handset 2 more frequently than normally regardless of the above-described notification timing.

The disclosure of the specification, drawings, and abstract included in Japanese Patent Application Number 2013-232390 filed on Nov. 8, 2013, is incorporated herein by reference in its entirety.

### INDUSTRIAL APPLICABILITY

The radio communication apparatus according to the present invention is suitable for use in digital cordless telephones.

### REFERENCE SIGNS LIST

1 Base unit
2 Handset
3 Charging cradle
101 Telephone line interface
102, 201 Main control section
102a, 201a Transmission power control section
102b, 201b Timer section
103, 202 Memory section
104, 203 Radio section
104a, 203a Level measurement section
104b, 203b Amplification section
104c Synchronization control section
105, 204 Antenna
110 Clock generation section
211 Charging circuit
212 Secondary battery
213 Power supply control section
301 External power supply connector
302 Power supply circuit

1. A wireless communication apparatus comprising:
a base unit; and
one or a plurality of handsets, wherein:
the base unit amplifies a control signal to a first transmission power value and transmits the control signal to each of the handsets using a control channel during a standby state, the control signal including information indicating the first transmission power value, and the control channel being used for transmitting the control signal;
each of the handsets measures a received signal strength indicator level of the control signal and determines a second transmission power value based on the measured value of the received signal strength indicator level and the first transmission power value;
each of the handsets amplifies a signal to a second transmission power value and transmits the signal to the base unit using only one slot at predetermined time intervals, the signal including information indicating the second transmission power value; and
the base unit measures a received signal strength indicator level of the signal transmitted from each of the handsets and determines the first transmission power value based on the measured value of the received signal strength indicator level and the second transmission power value.

2. The wireless communication apparatus according to claim 1, wherein:
each of the handsets comprises a counter for intermittent operation; and
when the counter expires, each of the handsets transmits the signal including the information indicating the second transmission power value to the base unit using a slot having a predetermined positional relationship with a slot of the control channel used for receiving the control signal.

3. The wireless communication apparatus according to claim 1, wherein, when a predetermined event occurs, each of the handsets transmits the signal including the information indicating the second transmission power value to the base unit using a slot having a predetermined positional relationship with a slot of the control channel used for receiving the control signal.

4. The wireless communication apparatus according to claim 3, wherein the predetermined event is an event that a propagation loss between the handset and the base unit exceeds a predetermined level.

5. The wireless communication apparatus according to claim 3, wherein the predetermined event is an event that a sensor of the handset detects a predetermined incident.

6. The wireless communication apparatus according to claim 5, wherein each of the handsets changes, in accordance with details of the predetermined incident, a number of frames for continuously transmitting the signal including the information indicating the second transmission power value.

7. The wireless communication apparatus according to claim 1, wherein the base unit measures a received signal strength indicator level of a signal transmitted from each of the handsets, calculates a propagation loss between the base unit and the handset based on the measured value of the received signal strength indicator level and the second transmission power value, and determines the first transmission power value based on a handset having a largest propagation loss, as a reference.

8. The wireless communication apparatus according to claim 1, wherein, when the handset cannot correctly receive a signal from the base unit, the handset continuously transmits the signal including the information indicating the second transmission power value over a plurality of frames.

9. The wireless communication apparatus according to claim 1, wherein, when it is determined that a propagation loss between the handset and the base unit increases to a value greater than a predetermined value, the handset continuously transmits the signal including the information indicating the second transmission power value over a plurality of frames.

10. The wireless communication apparatus according to claim 1, wherein:
when the base unit cannot receive a signal from a handset having a telephone function for a predetermined period of time, the base unit performs transmission power control with an assumption that the handset no longer exists, and
when the base unit cannot receive a signal from a handset that performs intermittent reception, for a predetermined period of time or longer, the base unit maintains a state where the transmission power value is set to a maximum.

11. The wireless communication apparatus according to claim 1, wherein:
the base unit transmits a message for requesting transmission of the second transmission power value using the channel for transmitting the control signal at predetermined time intervals; and
upon reception of the message transmitted from the base unit, each of the handsets transmits the signal including the information indicating the second transmission power value to the base unit using a slot having a predetermined positional relationship with a slot of the control channel used for receiving the control signal.

12. A transmission power control method in a wireless communication apparatus including a base unit and one or a plurality of handsets, the base unit performing radio communication in a time division multiple access (TDMA) scheme with each of the handsets in the wireless communication apparatus, the transmission power control method comprising:
amplifying, by the base unit, a control signal to a first transmission power value, and transmitting from the base unit, the control signal to each of the handsets using a control channel, the control signal including information indicating the first transmission power value, and the control channel being used for transmitting the control signal;
measuring, by each of the handsets, a received signal strength indicator level of the control signal;
determining, by the each of the handsets, a second transmission power value based on the measured value of the received signal strength indicator level and the first transmission power value;
amplifying, by each of the handsets, a signal to a second transmission power value, and transmitting the signal to the base unit using only one slot, the signal including information indicating the second transmission power value, the one slot having a predetermined positional relationship with the slot used for receiving the control signal;
measuring, by the base unit, a received signal strength indicator level of the signal transmitted from each of the handsets; and
determining, by the base unit, the first transmission power value based on the measured value of the received signal strength indicator level of the signal transmitted from each of the handsets and the second transmission power value.

13. The transmission power control method according to claim 12, wherein the determining the first transmission power value by the base unit comprises:
storing, for each of the handsets, the received signal strength indicator level of the signal transmitted from the handset;
obtaining a propagation loss between the base unit and each of the handsets based on the measured value of the stored received signal strength indicator level and the second transmission power value of a corresponding one of the handsets; and
determining the first transmission power value based on a handset with a largest propagation loss, as a reference.
